(19) United States
(12) Patent Application Publication
(10) Pub. No.: US 2015/0159086 A1
(43) Pub. Date: Jun. 11, 2015

(54) NEMATIC LIQUID CRYSTAL COMPOSITION

(71) Applicant: DIC Corporation, Tokyo (JP)

(72) Inventors: Masakazu Kaneoya, Kita-adachi-gun (JP); Kiyofumi Takeuchi, Kita-adachi-gun (JP); Masashi Osawa, Kita-adachi-gun (JP); Kenta Tojyo, Kita-adachi-gun (JP); Tetsuo Kusumoto, Kita-adachi-gun (JP)

(73) Assignee: DIC CORPORATION, Tokyo (JP)

(21) Appl. No.: 14/386,154

(22) PCT Filed: Mar. 13, 2013
(86) PCT No.: PCT/JP2013/057053

§ 371 Date: Feb. 3, 2015

(30) Foreign Application Priority Data
Mar. 19, 2012 (JP) 2012-061932

(51) Int. Cl. C09K 19/32; C09K 19/54

(52) U.S. Cl. CPC C09K 19/322; C09K 19/542; C09K 2019/548

(57) ABSTRACT

The nematic liquid crystal composition according to the present invention is used for, for example, producing a liquid crystal display element used in TN mode, OCB mode, ECB mode, IPS mode, or VA-IPS mode. The liquid crystal composition has a positive dielectric anisotropy and allows reductions in refractive-index anisotropy and nematic phase-isotropic liquid phase transition temperature and an increase in the lower limit temperature of a nematic phase to be suppressed. As a result, the liquid crystal composition has a sufficiently low viscosity without deteriorating the temperature range of a nematic phase. The liquid crystal composition allows high-speed response and high display quality to be realized, suppresses faulty display, and is suitably used as a practical liquid crystal composition.

### TECHNICAL FIELD

The present invention relates to a nematic liquid crystal composition having a positive dielectric anisotropy (Δ∈) which can be suitably used as a material for electro-optical liquid crystal displays.

### BACKGROUND ART

Liquid crystal display elements have been used in clocks, electronic calculators, various measurement machines, panels for automobiles, word processors, electronic personal organizers, printers, computers, TVs, clocks, advertisement display boards, and the like. Representative examples of a liquid crystal display method include TN (twisted nematic) type, STN (super twisted nematic) type, vertical-alignment type using a TFT (thin-film transistor), and IPS (in-plane switching) type. It is desired that a liquid crystal composition used for producing these liquid crystal display elements be stable against external factors such as moisture, air, heat, and light; exhibit a liquid-crystal phase over as wide a temperature range as possible around room temperature; and have a low viscosity and a low drive voltage. The liquid crystal composition is composed of a few to several tens of types of compounds in order to optimize, for example, the dielectric anisotropy (Δ∈) and/or the refractive-index anisotropy (Δn) of the liquid crystal composition for each individual display element.

While a liquid crystal composition having a negative Δ∈ is used for producing vertical-alignment-type displays, a liquid crystal composition having a positive Δ∈ is used for producing horizontal-alignment-type displays such as a TN-type display, a STN-type display, and an IPS-type display. There has been reported a drive mode in which a liquid crystal composition having a positive Δ∈ is vertically aligned while a voltage is not applied and display is performed by applying an in-plane electric field. Thus, there has been a growing demand for a liquid crystal composition having a positive Δ∈. On the other hand, there has been a demand for low-voltage driving, high-speed response, and a wide operating temperature range regardless of the drive mode. In other words, there has been a demand for a positive Δ∈ having a large absolute value, a low viscosity (η), and a high nematic phase-isotropic liquid phase transition temperature (Tₙᵢ). In addition, on the basis of the configuration of the product of Δn and cell gap (d), Δn×d, it is necessary to control Δn of a liquid crystal composition to be within an appropriate range depending on the cell gap. Furthermore, in the case where liquid crystal display elements are used for producing TVs or the like, primary importance is attached to high-speed response, which leads to a demand for a liquid crystal composition having a low γ₁.

There have been disclosed liquid crystal compositions (PTLs 1 to 4) that include a compound represented by Formula (A-1) or (A-2) having a positive Δ∈. However, these liquid crystal compositions have not yet reached a point where a sufficiently low viscosity is achieved.

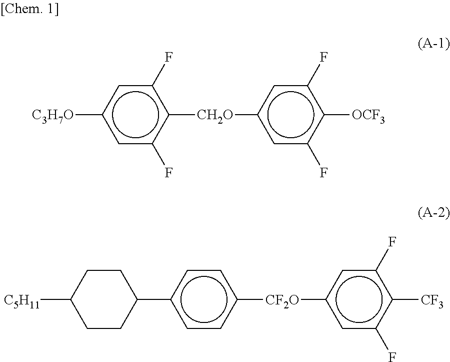

### CITATION LIST

### Patent Literature

PTL 1: WO96/032365

PTL 2: Japanese Unexamined Patent Application Publication No. 09-157202

PTL 3: WO98/023564

PTL 4: Japanese Unexamined Patent Application Publication No. 2003-183656

### SUMMARY OF INVENTION

### Technical Problem

An object of the present invention is to provide a liquid crystal composition having a sufficiently low viscosity (η) and a positive dielectric anisotropy (ΔΣ) without the refractive-index anisotropy (Δn) and nematic phase-isotropic liquid phase transition temperature (Tₙᵢ) of the liquid crystal composition being reduced or increased.

### Solution to Problem

The inventor of the present invention has studied various fluorobenzene derivatives and found that the above-described problems may be addressed using specific compounds in combination. Thus, the present invention has been made.

The present invention provides a liquid crystal composition having a positive dielectric anisotropy, the liquid crystal composition including one or more compounds selected from compounds represented by General Formula (LC0-1) and/or General Formula (LC0-2) and one or more compounds selected from the group consisting of compounds represented by General Formulae (LC1) to (LC5). The present invention also provides a liquid crystal display element including the above-described liquid crystal composition.

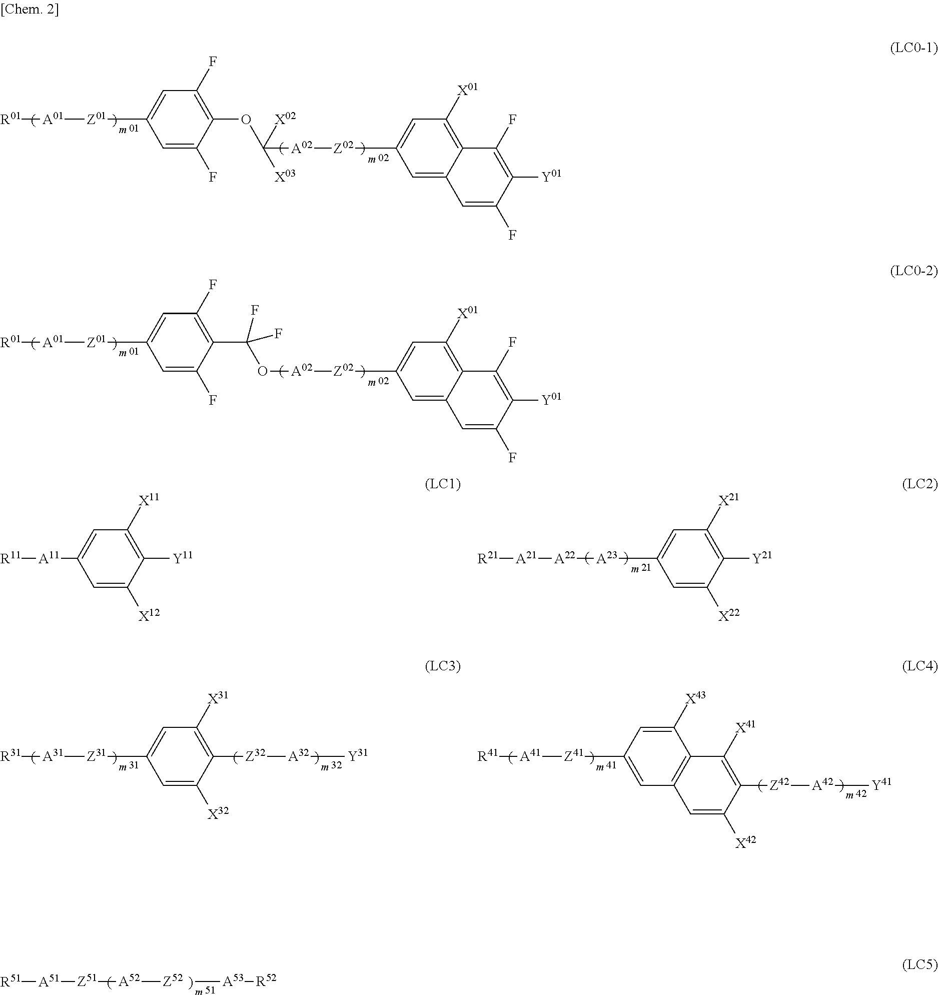

(wherein R⁰¹ to R⁴¹ each independently represent an alkyl group having a carbon number of 1 to 15, one or more —CH₂— of the alkyl group may be substituted by —O—, —CH═CH—, —CO—, —OCO—, —COO—, —C≡C—, —CF₂O—, or —OCF₂— so that an oxygen atom is not directly adjacent to another oxygen atom, and one or more hydrogen atoms of the alkyl group may be substituted by a halogen; R⁵¹ and R⁵² each independently represent an alkyl group having a carbon number of 1 to 15, and one or more —CH₂— of the alkyl group may be substituted by —O—, —CH═CH—, —CO—, —OCO—, —COO—, or —C≡C— so that an oxygen atom is not directly adjacent to another oxygen atom; A⁰¹ to A⁴² each independently represent any one of the following structures:

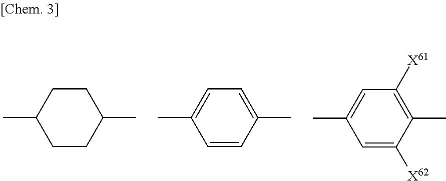

(where one or more —CH₂— in the cyclohexane ring may be substituted by —O— so that an oxygen atom is not directly adjacent to another oxygen atom; one or more —CH═ in the benzene ring may be substituted by —N═ so that a nitrogen atom is not directly adjacent to another nitrogen atom; and X⁶¹ and X⁶² each independently represent —H, —Cl, —F, —CF₃, or —OCF₃); A⁵¹ to A⁵³ each independently represent any one of the following structures:

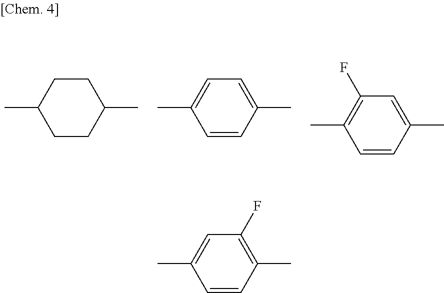

(where one or more —CH₂CH₂— in the cyclohexane ring may be substituted by —CH═CH—, —CF₂O—, or —OCF₂—; one or more —CH═ in the benzene ring may be substituted by —N═ so that a nitrogen atom is not directly adjacent to another nitrogen atom); X⁰¹ to X⁰³ each represent a hydrogen atom or a fluorine atom; X¹¹ to X⁴³ each independently represent —H, —Cl, —F, —CF₃, or —OCF₃; Y⁰¹ to Y⁴¹ each represent —Cl, —F, —CF₃, or —OCF₃; Z⁰¹ and Z⁰² each independently represent a single bond, —CH═CH—, —C≡C—, —CH₂CH₂—, —(CH₂)₄—, —OCH₂—, —CH₂O—, —OCF₂—, or —CF₂O—; Z³¹ to Z⁴² each independently represent a single bond, —CH═CH—, —C≡C—, —CH₂CH₂—, —(CH₂)₄—, —OCH₂—, —CH₂O—, —OCF₂—, or —CF₂O—; at least one of Z³¹ and Z³² is not a single bond; Z⁵¹ and Z⁵² each independently represent a single bond, —CH═CH—, —C≡C—, —CH₂CH₂—, —(CH₂)₄—, —OCH₂—, —CH₂O—, —OCF₂—, or —CF₂O—; m⁰¹ to m⁵¹ each independently represent an integer of 0 to 3; m³¹+m³² and m⁴¹+m⁴² are each independently 1, 2, 3, or 4; and, in the case where there are a plurality of A⁰¹'s, A⁰²'s, A⁰³'s, A²³'s, A³¹'s A³²'s, A⁴¹'s, A⁴²'s, A⁵²'s, Z⁰¹'s, Z⁰²'s, Z³¹'s, Z³²'s, Z⁴¹'s, Z⁴²'s and/or Z⁵²'s, they may be all identical or different and Z⁴¹'s each independently represent a single bond, —CH═CH—, —C≡C—, —CH₂CH₂—, or —(CH₂)₄— when m⁴² is 0).

### Advantageous Effects of Invention

The liquid crystal composition according to the present invention has a positive Δ∈ having a large absolute value. The liquid crystal composition has a low η, a low rotational viscosity (γ₁), and a good liquid-crystal property and exhibits a stable liquid-crystal phase over a wide temperature range. The liquid crystal composition is chemically stable to heat, light, water, and the like and has good solubility. Therefore, the liquid crystal composition is a practical, highly reliable liquid crystal composition that has good phase stability at low temperatures and allows low-voltage drive to be realized.

### DESCRIPTION OF EMBODIMENTS

The liquid crystal composition according to the present invention includes one or more compounds selected from compounds represented by General Formula (LC0-1) and/or General Formula (LC0-2) described above and one or more compounds selected from the group consisting of compounds represented by General Formulae (LC1) to (LC5). The liquid crystal composition is considered to be a practical liquid crystal composition since it exhibits a stable liquid-crystal phase even at low temperatures.

In General Formulae (LC0-1) to (LC5), R⁰¹ to R⁴¹ each independently represent an alkyl group having a carbon number of 1 to 15. One or more —CH₂— of the alkyl group may be substituted by —O—, —CH═CH—, —CO—, —OCO—, —COO—, —C≡C—, —CF₂O—, or —OCF₂— so that an oxygen atom is not directly adjacent to another oxygen atom. One or more hydrogen atoms of the alkyl group may optionally be substituted by a halogen. R⁰¹ to R⁴¹ are preferably an alkyl group having a carbon number of 1 to 8, an alkenyl group having a carbon number of 2 to 8, or an alkoxy group having a carbon number of 1 to 8 and are preferably straight chains. R⁵¹ and R⁵² each independently represent an alkyl group having a carbon number of 1 to 15. One or more —CH₂— of the alkyl group may be substituted by —O—, —CH═CH—, —CO—, —OCO—, —COO—, or —C≡C— so that an oxygen atom is not directly adjacent to another oxygen atom. R⁵¹ and R⁵² are preferably an alkyl group having a carbon number of 1 to 8, an alkenyl group having a carbon number of 2 to 8, or an alkoxy group having a carbon number of 1 to 8 and are preferably straight chains. A⁰¹ to A⁴² are preferably each independently a trans-1,4-cyclohexylene group, an 1,4-phenylene group, a 3-fluoro-1,4-phenylene group, or a 3,5-difluoro-1,4-phenylene group. A⁵¹ to A⁵³ are preferably each independently a trans-1,4-cyclohexylene group, an 1,4-phenylene group, a 2-fluoro-1,4-phenylene group, or a 3-fluoro-1,4-phenylene group. X⁰¹ to X⁰³ are preferably each a hydrogen atom or a fluorine atom. X¹¹ to X⁴³ are preferably each independently a hydrogen atom or a fluorine atom. Y⁰¹ to Y⁴¹ are preferably each —F, —CF₃, or —OCF₃.

Z⁰¹ and Z⁰² are preferably each independently a single bond, —CH═CH—, —C≡C—, —CH₂CH₂—, —(CH₂)₄—, —OCH₂—, —CH₂O—, —OCF₂—, or —CF₂O—. In the case where one of Z⁰¹ and Z⁰² represents —CH═CH—, —C≡C—, —CH₂CH₂—, —(CH₂)₄—, —OCH₂—, —CH₂O—, —OCF₂—, or —CF₂O—, the other preferably represents a single bond. It is further preferable that both Z⁰¹ and Z⁰² represent a single bond. Z³¹ to Z⁴² are preferably each independently a single bond, —CH═CH—, —C≡C—, —CH₂CH₂—, —(CH₂)₄—, —OCH₂—, —CH₂O—, —OCF₂—, or —CF₂O—. At least one of Z³¹ and Z³² is not a single bond. Z⁴¹'s each independently represent a single bond, —CH═CH—, —C≡C—, —CH₂CH₂—, or —(CH₂)₄-when m⁴² is 0. Z⁵¹ and Z⁵² are preferably each independently a single bond, —CH═CH—, —C≡C—, —CH₂CH₂—, —(CH₂)₄—, —OCH₂—, —CH₂O—, —OCF₂—, or —CF₂O—, are further preferably each independently a single bond, —CH₂CH₂—, —OCF₂—, or —CF₂O—, and are particularly preferably each independently a single bond. It is preferable that m⁰¹ and m⁰² are each independently an integer of 0 to 2 and m²¹ is an integer of 0 or 1. It is preferable that m³¹ to m⁴² are each independently an integer 2, or 3. It is preferable that m⁵¹ is an integer of 1 or 2. In the case where there are a plurality of A⁰¹'s, A⁰²'s, A²³'s A³¹'s, A³²'s, A⁴¹'s, A⁴²'s, A⁵²'s, Z⁰¹'s, Z⁰¹'s, Z³¹'s, Z³²'s, Z⁴¹'s, Z⁴²'s and/or Z⁵²'s, they may be all identical or different.

It is more preferable that the liquid crystal compound represented by General Formula (LC0-1) or General Formula (LC0-2) is a compound represented by any one of General Formulae (LC0-1-1) to (LC0-2-4) below.

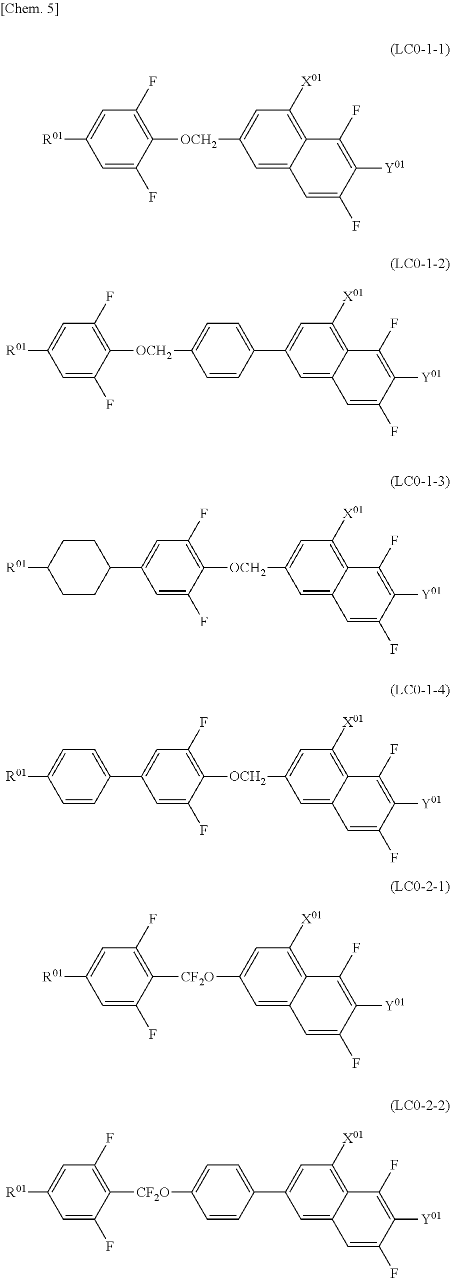

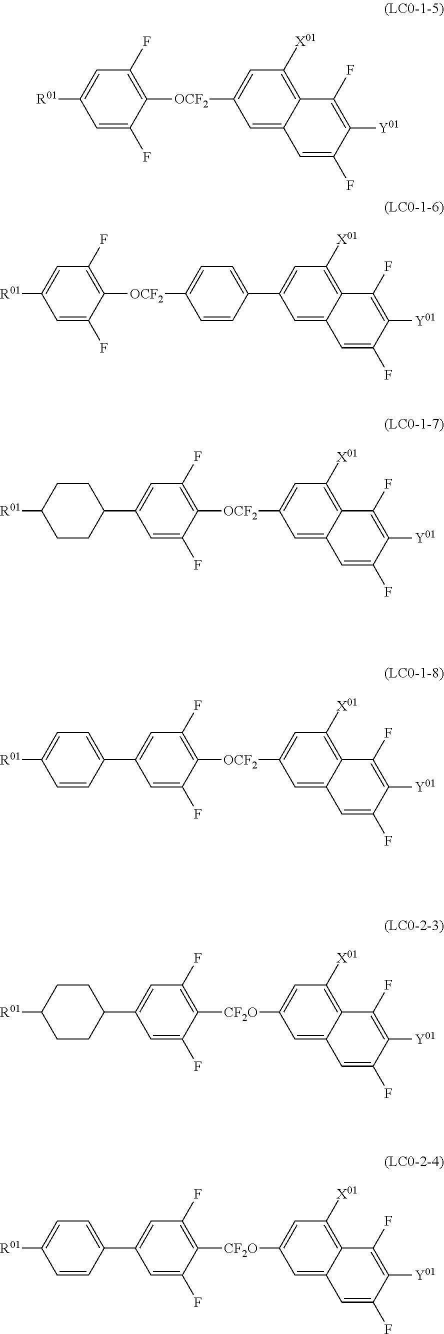

(in General Formulae (LC0-1-1) to (LC0-2-4), R⁰¹, X⁰¹, and Y⁰¹ represent the same things as those described in Claim 1, respectively)

It is more preferable that the compound represented by General Formula (LC1) is a compound represented by any one of General Formulae (LC1-1) to (LC1-4) below.

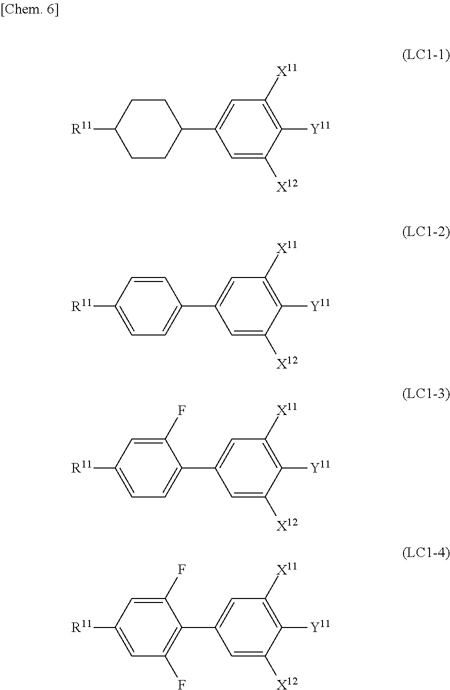

(in General Formulae (LC1-1) to (LC1-4), R¹¹, X¹¹, X¹², and Y¹¹ represent the same things as those described in Claim 1, respectively)

It is more preferable that the compound represented by General Formula (LC2) is a compound represented any one of General Formulae (LC2-1) to (LC2-8) below.

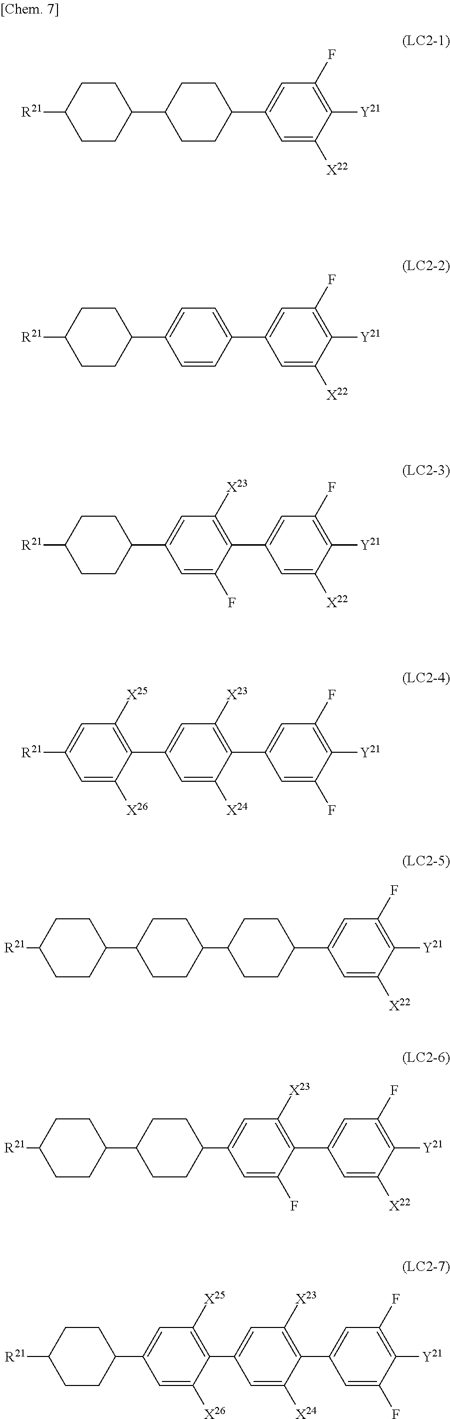

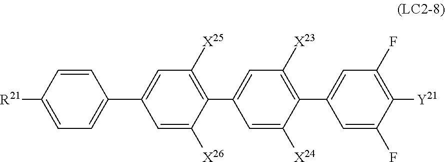

(in General Formulae (LC2-1) to (LC2-8), X²³, X²⁴, X²⁵, and X²⁶ each independently represent a hydrogen atom, Cl, F, CF₃, or OCF₃; X²², R²¹, and Y²¹ represent the same things as those described in Claim 1, respectively)

It is preferable that the compound represented by General Formula (LC3) is a compound represented by any one of General Formulae (LC3-1) to (LC3-121) below.

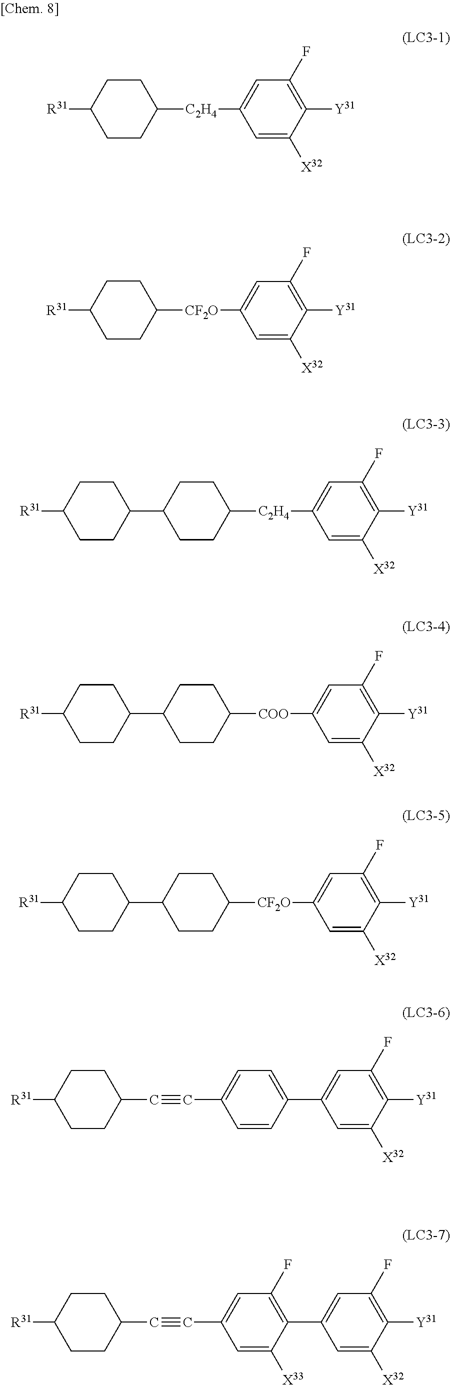

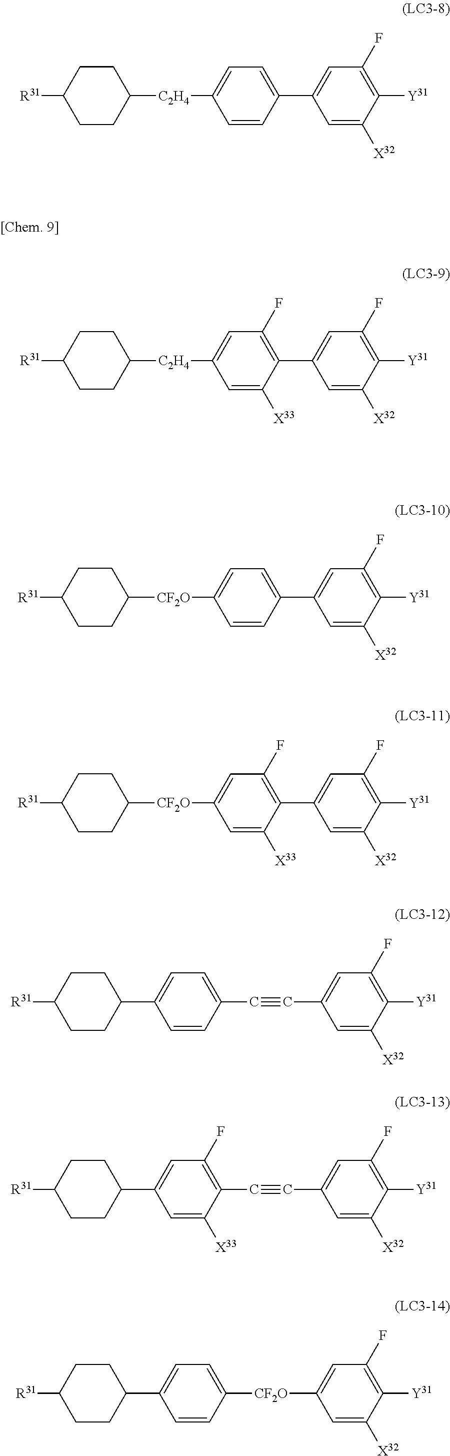

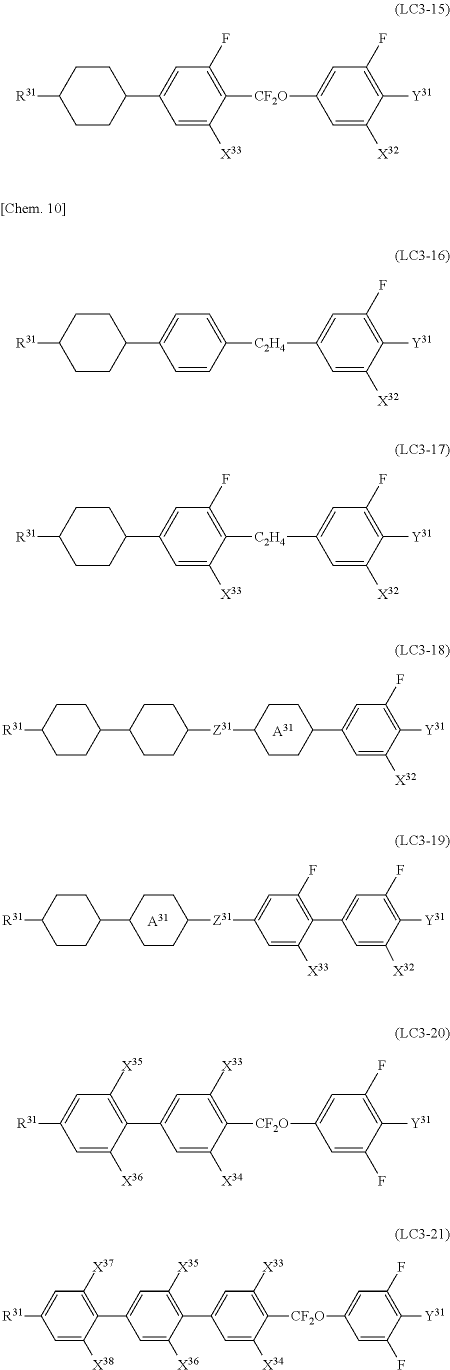

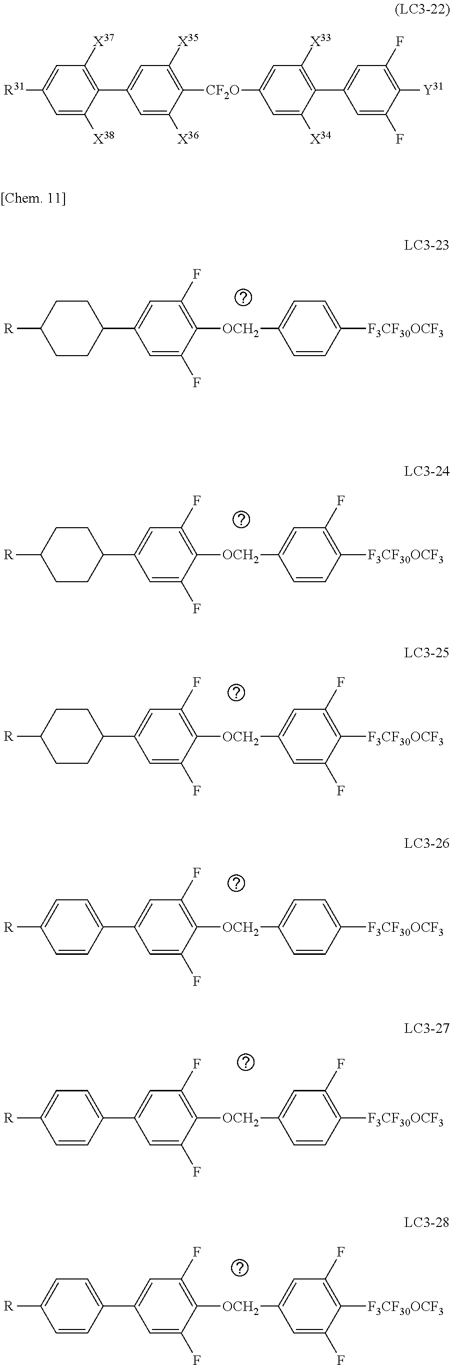

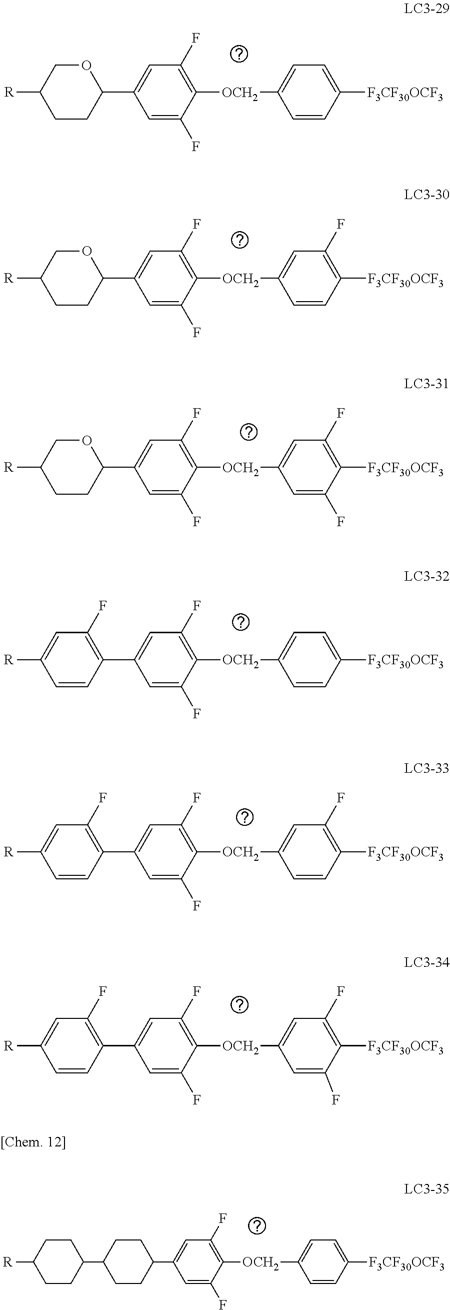

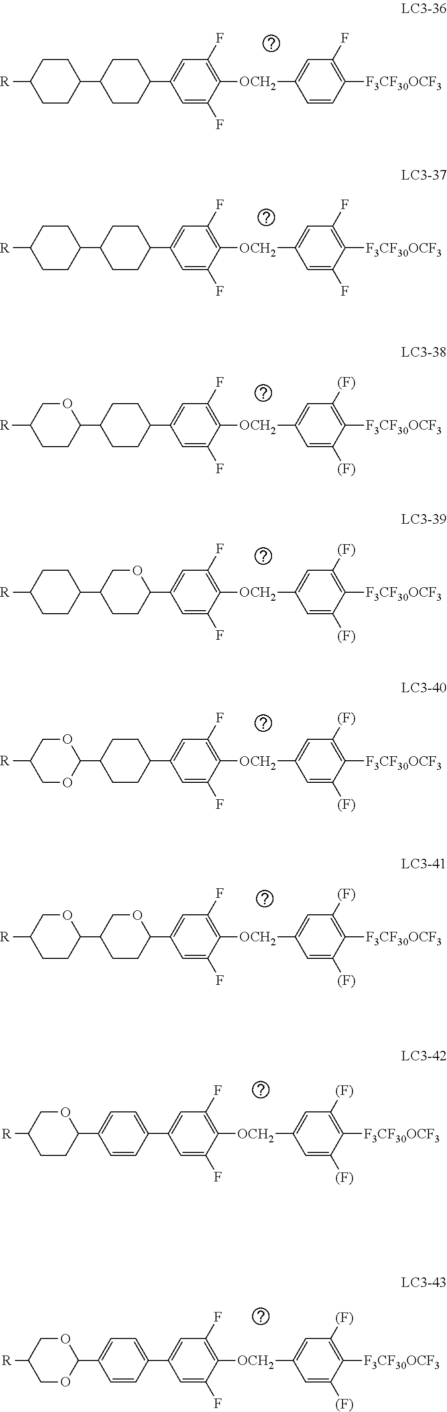

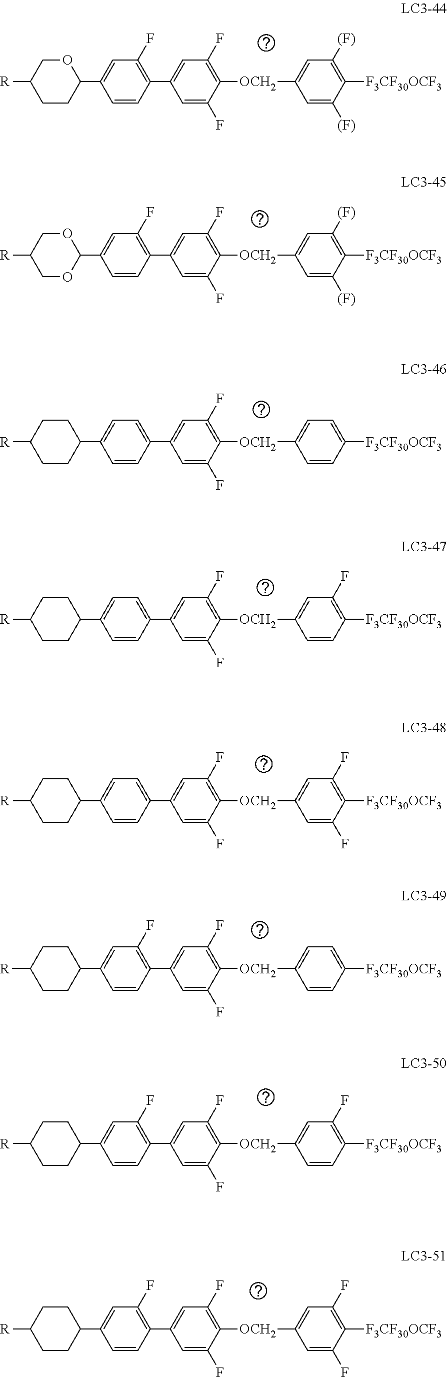

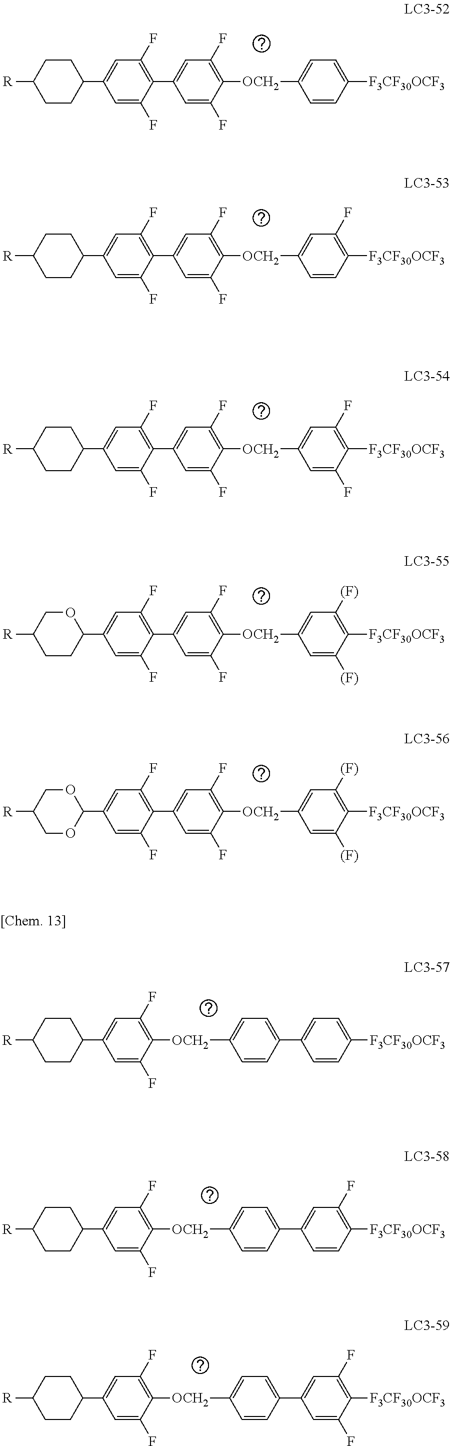

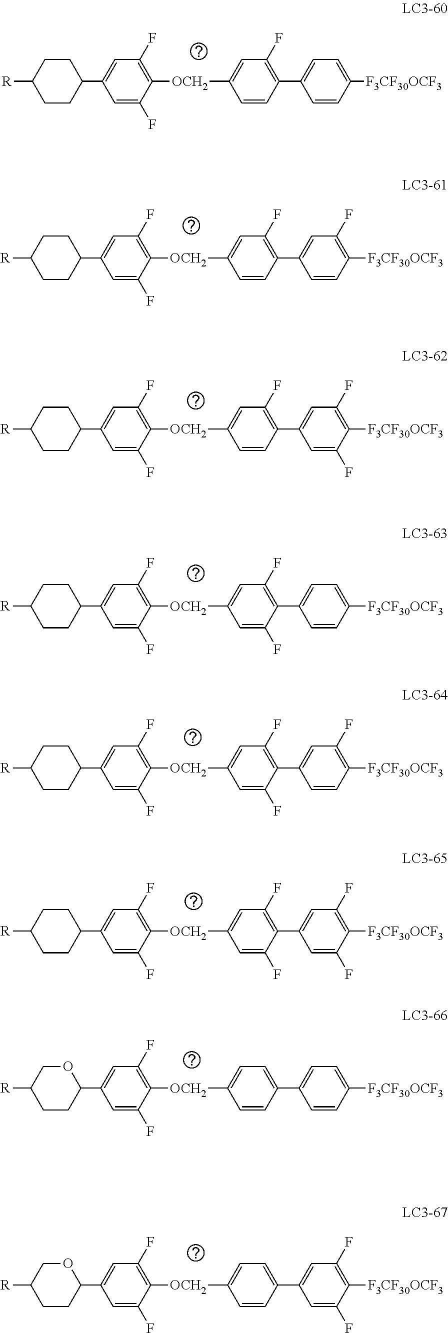

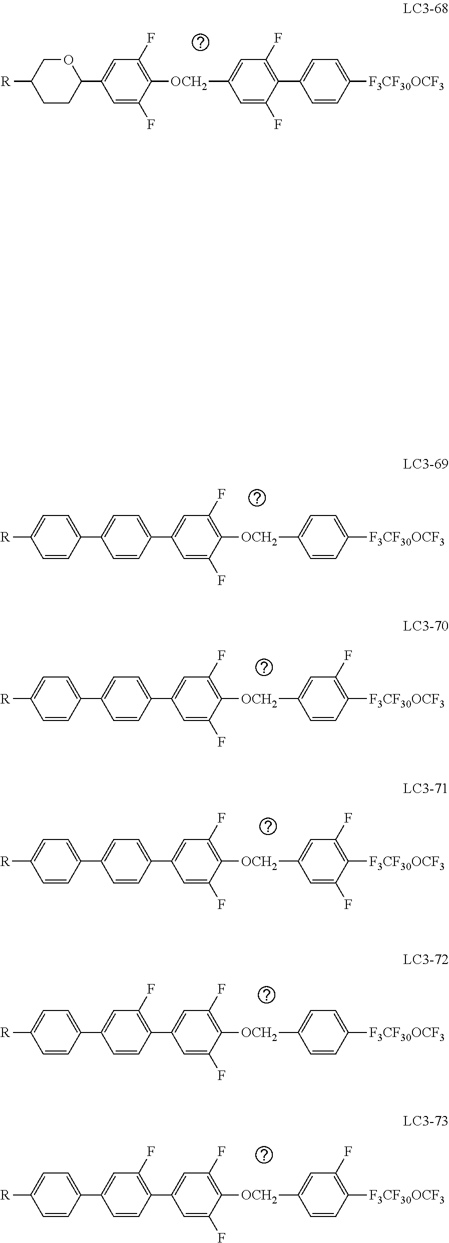

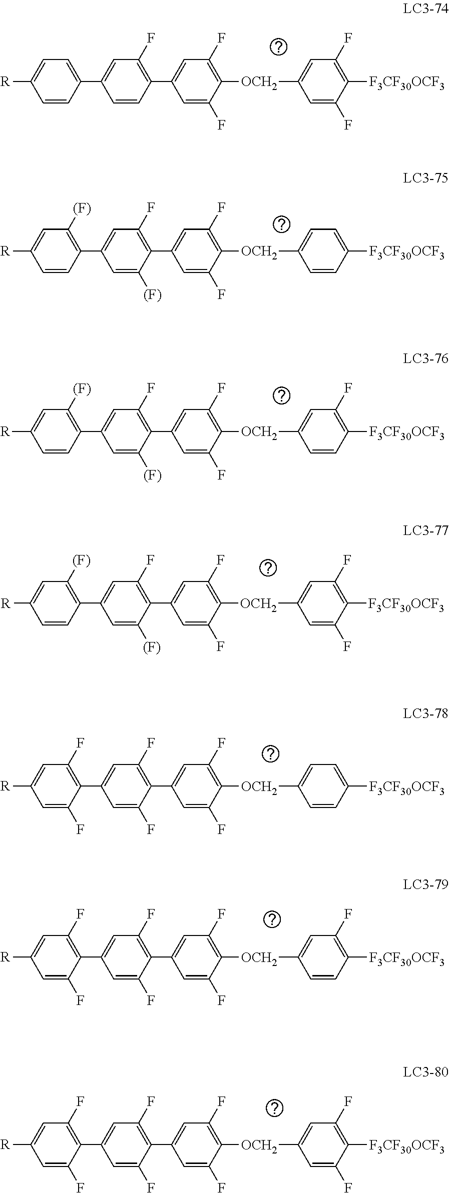

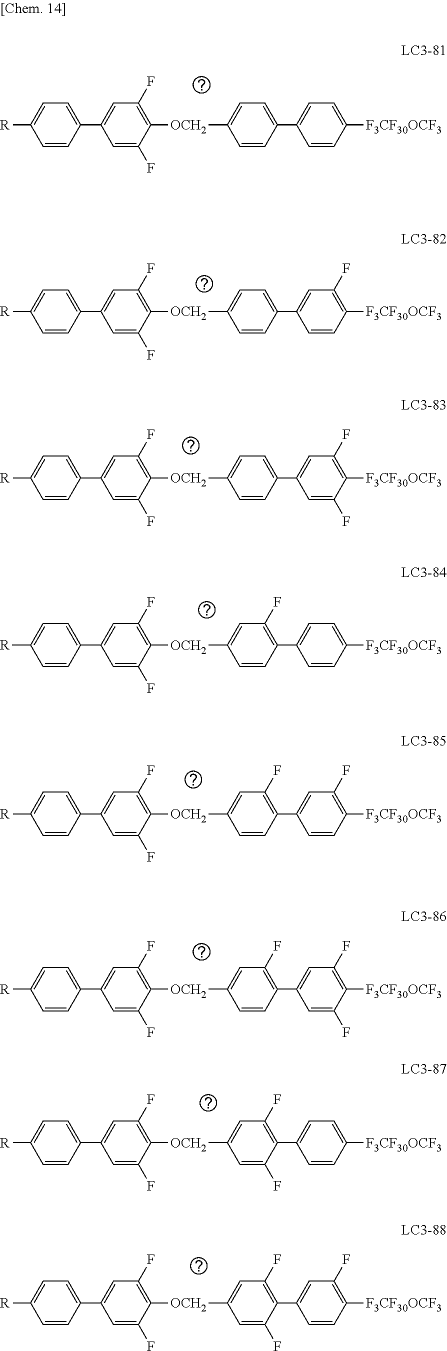

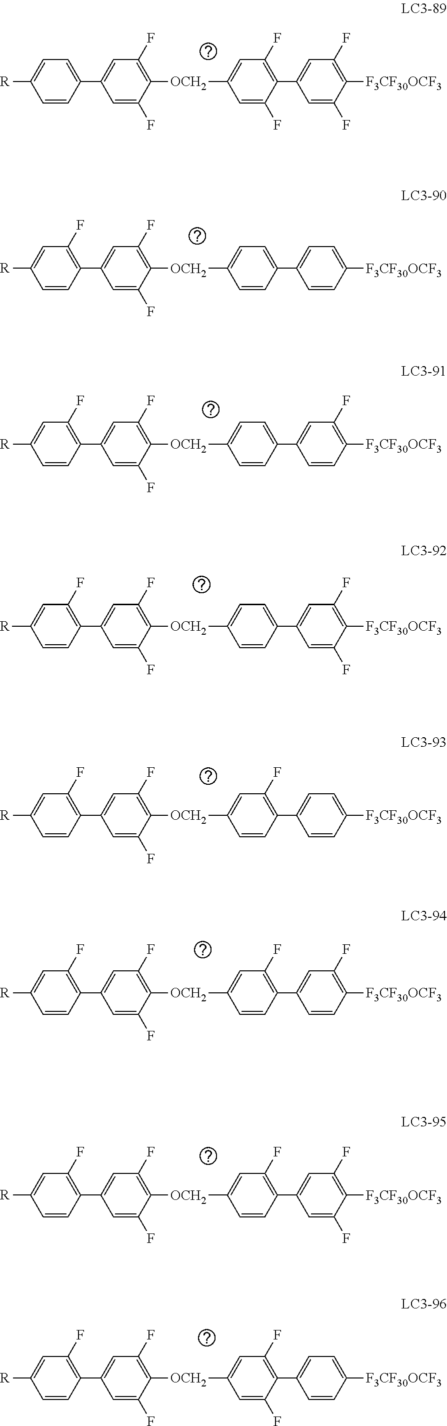

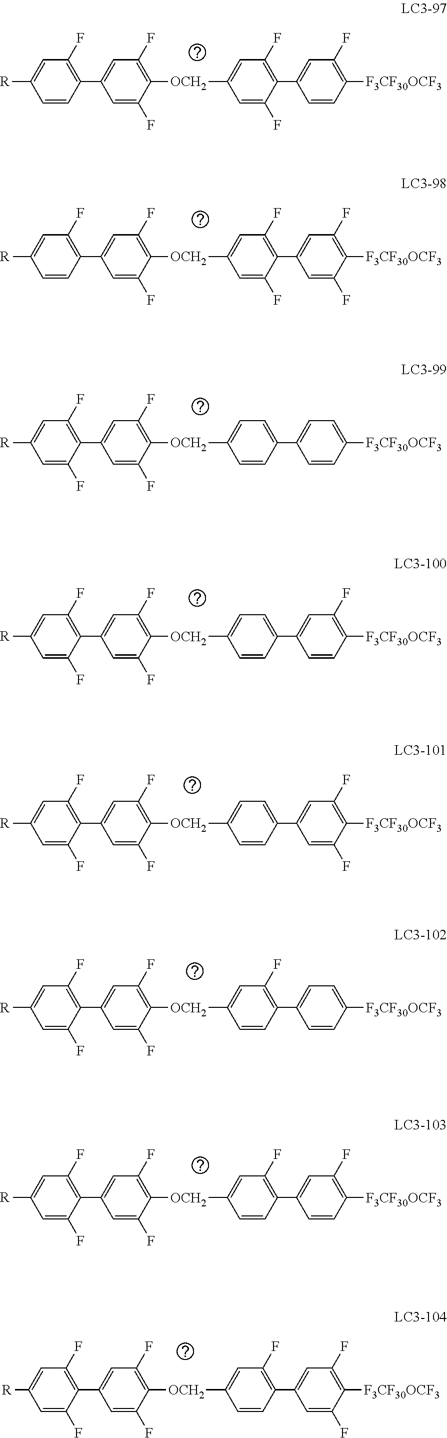

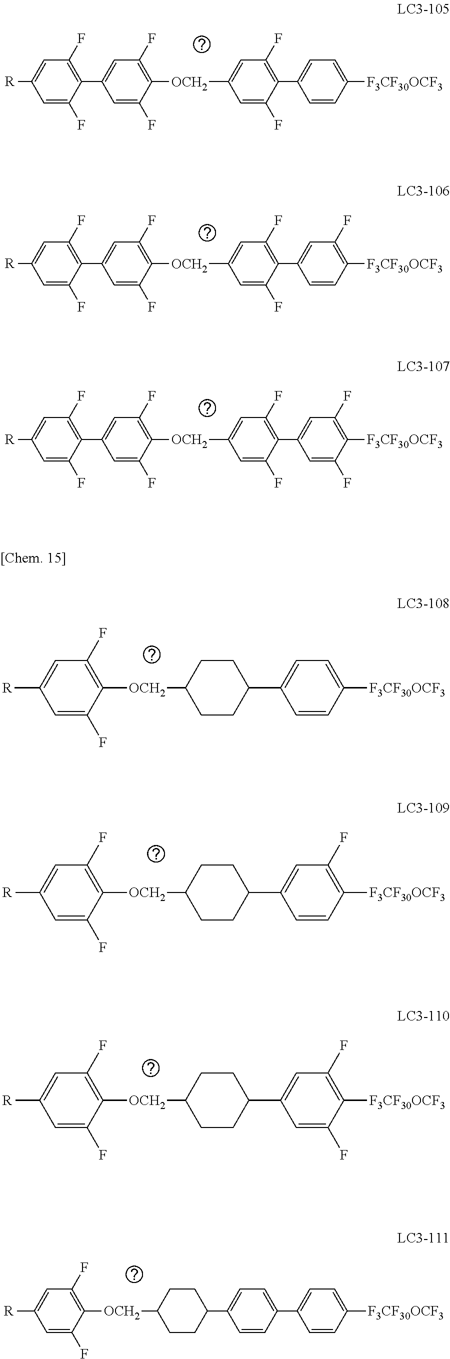

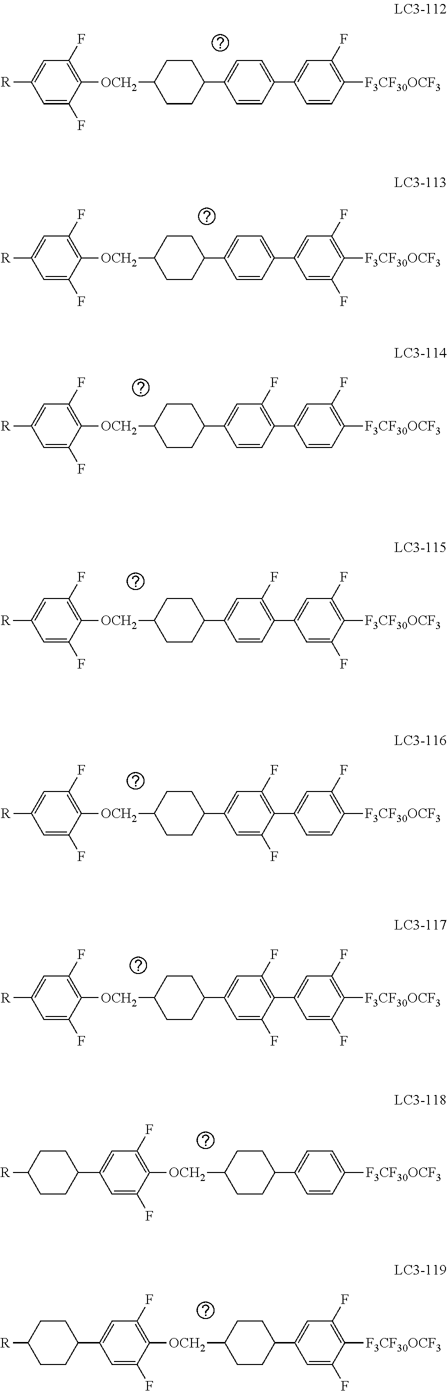

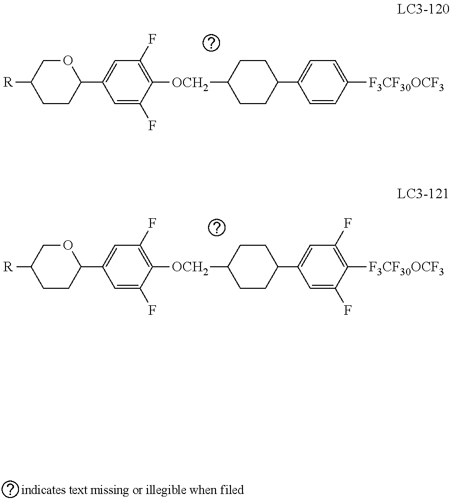

(in General Formulae (LC3-1) to (LC3-121), X³³, X³⁴, X³⁵, X³⁶, X³⁷, and X³⁸ each independently represent H, Cl, F, CF₃, or OCF₃; X³², R³¹, A³¹, Y³¹, and Z³¹ represent the same things as those described in Claim 1, respectively; R represents R³¹; F, CF₃, OCF₃ represents any one of F, CF₃, and OCF₃; and (F) represents any one of H and F)

It is preferable that the compound represented by General Formula (LC4) is a compound represented by any one of General Formulae (LC4-1) to (LC4-12) below.

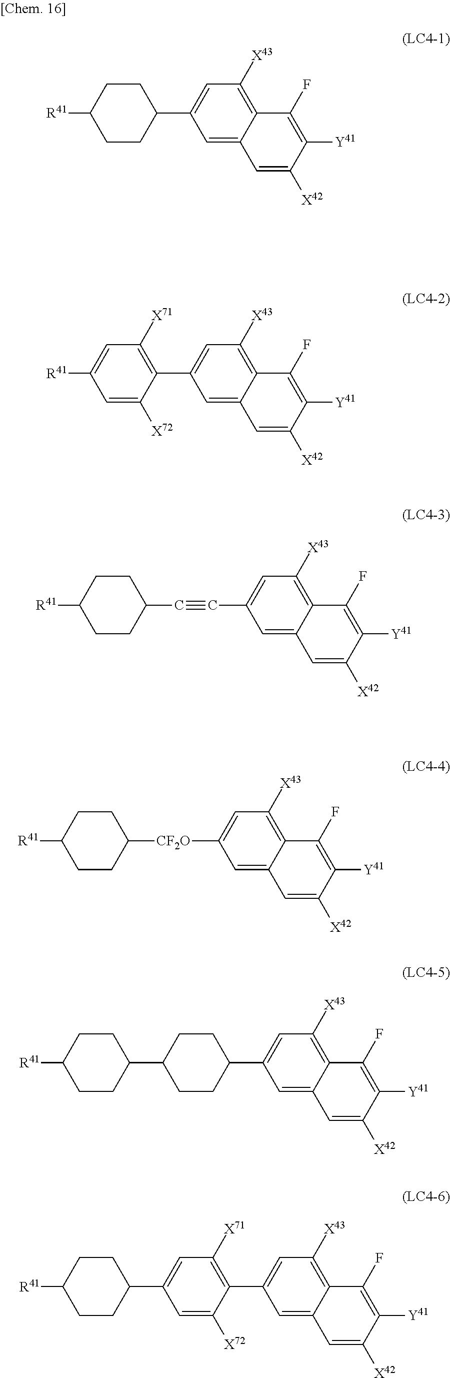

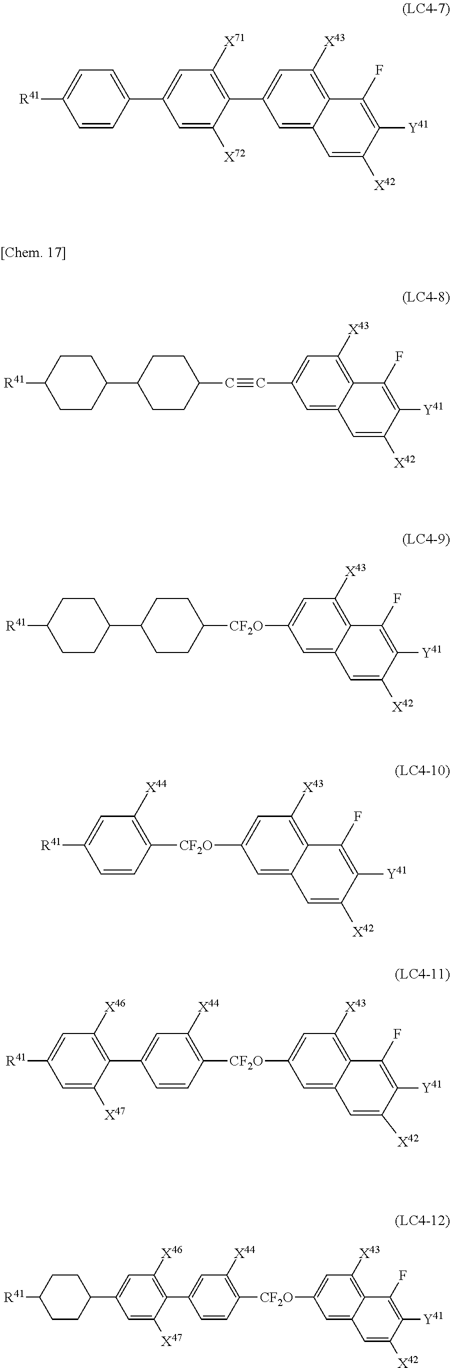

(in General Formulae (LC4-1) to (LC4-12), X⁴⁴, X⁴⁶, X⁴⁷, X⁷¹, and X⁷² each independently represent H, Cl, F, CF₃, or OCF₃; and X⁴², X⁴³, R⁴¹, and Y⁴¹ represent the same things as those described in Claim 1, respectively)

It is preferable that the compound represented by General Formula (LC5) is a compound represented by any one of General Formulae (LC5-1) to (LC5-14) below.

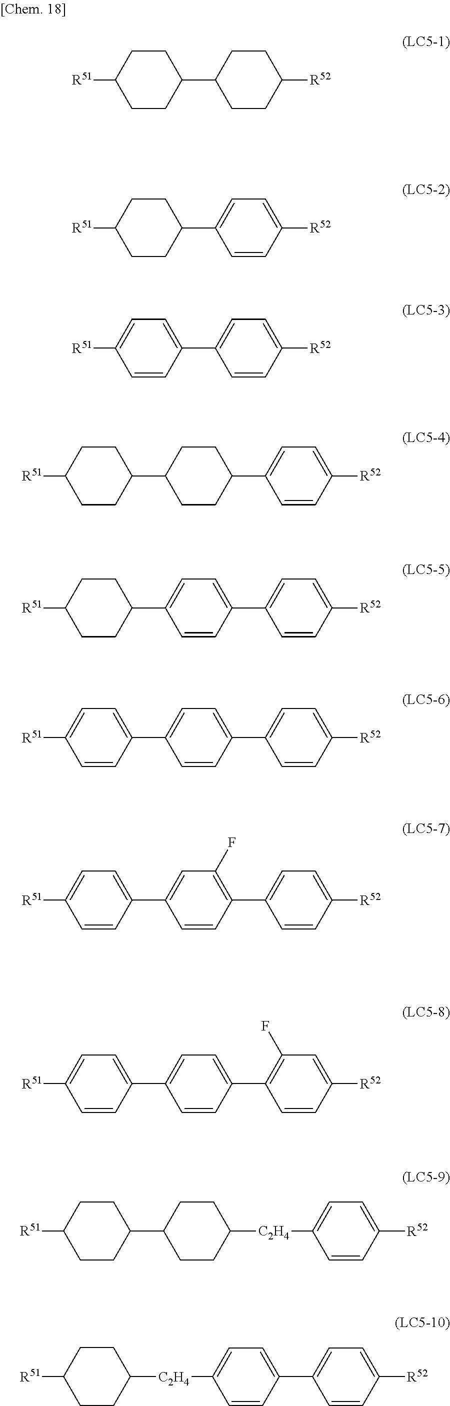

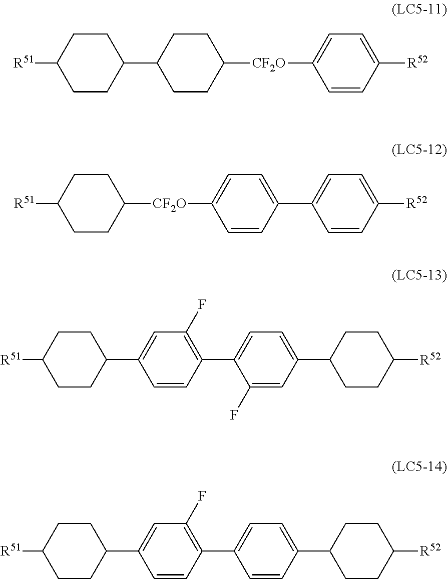

(in General Formulae (LC5-1) to (LC5-14), R⁵¹ and R⁵² represent the same things as those described in Claim 1, respectively)

The content of the compounds represented by General Formula (LC0-1) and/or General Formula (LC0-2) in the liquid crystal composition according to the present invention is preferably 5% to 50% by mass and is further preferably 10% to 40% by mass. The content of the compounds represented by General Formula (LC-1), the content of the compounds represented by General Formula (LC-2), the content of the compounds represented by General Formula (LC-3), and the content of the compounds represented by General Formula (LC-4) in the liquid crystal composition according to the present invention are preferably each independently 10& to 60& by mass and are further preferably each independently 10% to 40% by mass. The content of the compounds represented by General Formula (LC-5) in the liquid crystal composition according to the present invention is preferably 10 to 90 by mass and is further preferably 15% to 70% by mass.

Optionally, the liquid crystal composition according to the present invention may include a polymerizable compound in order to prepare, for example, a polymer-stabilized (PS)-mode liquid crystal display element. An example of the polymerizable compound that can be used is a photopolymerizable monomer that undergoes polymerization when irradiated with an energy beam such as light. For example, a polymerizable compound having a liquid-crystal skeleton including a plurality of six-membered rings bonded to one another, such as a biphenyl derivative and a terphenyl derivative, may be used. Specifically, the polymerizable compound is preferably a polymerizable compound represented by General Formula (PC1).

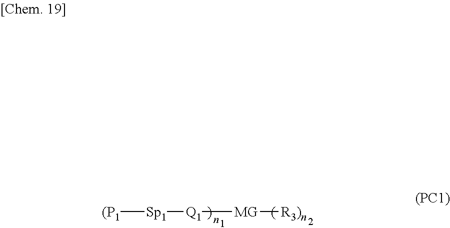

(in General Formula (PC1), P₁ represents a polymerizable functional group; Sp₁ represents a spacer group having 0 to 20 carbon atoms; Q₁ represents a single bond, —O—, —NH—, —NHCOO—, —OCONH—, —CH═CH—, —CO—, —COO—, —OCO—, —OCOO—, —OOCO—, —CH═CH—, —CH═CH—OCO—, —OCO—CH═CH—, or —C≡C—; n₁ and n₂ are each independently 1, 2, or 3; MG represents a mesogenic group or a mesogenic supporting group; and R₃ represents a halogen atom, a cyano group, or an alkyl group having 1 to 25 carbon atoms and one or more CH₂ groups of the alkyl group may be substituted by —O—, —S—, —NH—, —N(CH₂)—, —CO—, —COO—, —OCO—, —OCOO—, —SCO—, —COS—, or —C≡C— so that an O atom is not directly adjacent to another O atom, or R₃ represents P₂-Sp₂-Q₂- (where P₂, Sp₂, Q₂ independently represent the same things as P₁, Sp₁, and Q₁, respectively))

It is more preferable that MG in the polymerizable compound represented by General Formula (PC1) is a polymerizable compound represented by the following structure:

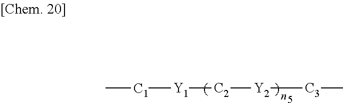

(in this formula, C₁ to C₃ each independently represent an 1,4-phenylene group, an 1,4-cyclohexylene group, an 1,4-cyclohexenyl group, a tetrahydropyran-2,5-diyl group, an 1,3-dioxane-2,5-diyl group, a tetrahydrothiopyran-2,5-diyl group, an 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, an 1,2,3,4-tetrahydronaphthalene-2,6-diyl group, a 2,6-naphthylene group, a phenanthrene-2,7-diyl group, a 9,10-dihydrophenanthrene-2,7-diyl group, an 1,2,3,4,4a,9,10a-octahydrophenanthrene-2,7-diyl group, or a fluorene-2,7-diyl group; the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene-2,7-diyl group, and the fluorene-2,7-diyl group may optionally have, as substituents, one or more F, Cl, CF₃, OCF₃, a cyano group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkenyl group having 2 to 8 carbon atoms, an alkenyloxy group having 2 to 8 carbon atoms, an alkenoyl group having 2 to 8 carbon atoms, or an alkenoyloxy group having 2 to 8 carbon atoms; Y₁ and Y₂ each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, or a single bond; and n₅ is 0, 1, or 2).

It is more preferable that Sp₁ and Sp₂ each independently represent an alkylene group. The alkylene group may optionally be substituted by one or more halogen atoms or CN. One or more CH₂ groups in the alkylene group may optionally be substituted by —O—, —S—, —NH—, —N(CH₃)—, —CO—, —COO—, —OCO—, —OCOO—, —SCO—, —COS—, or —C≡C— so that an O atom is not directly adjacent to another O atom.

It is more preferable that P1 and P2 are each independently represented by any one of General Formulae (PC1-a) to (PC1-d) below.

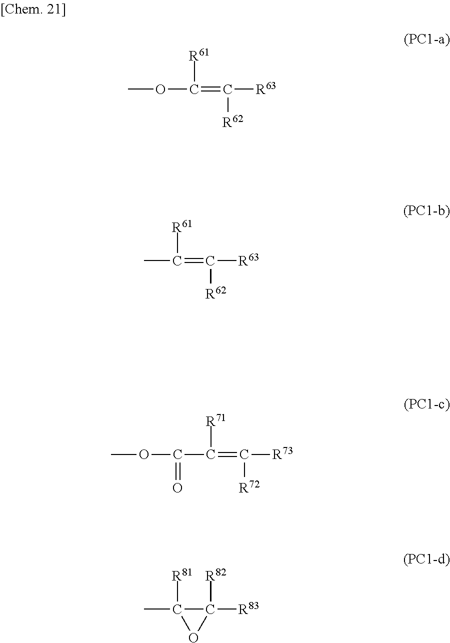

(in General Formulae (PC1-a) to (PC1-d), R⁶¹ to R⁶³, R⁷¹ to R⁷³, and R⁸¹ to R⁸³ each independently represent a hydrogen atom, a halogen atom, or an alkyl group having 1 to 5 carbon atoms)

Specifically, the polymerizable compound represented by General Formula (PC1) is preferably a polymerizable compound represented by General Formula (PC1)-1 or General Formula (PC1)-2.

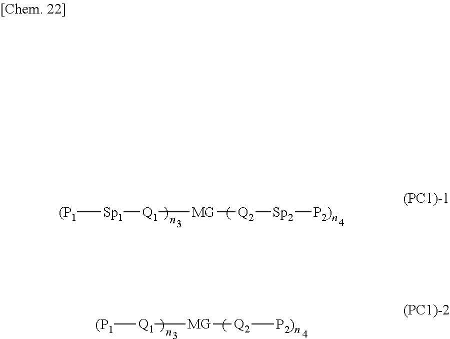

(in General Formulae (PC1)-1 and (PC1)-2, P₁, Sp₁, Q₁, P₂, Sp₂, Q₂, and MG represent the same things as those shown in General Formula (PC1), respectively; and n₃ and n₄ are each independently 1, 2, or 3)

More specifically, the polymerizable compound represented by General Formula (PC1) is more preferably a polymerizable compound represented by any one of General Formulae (PC1)-3 to (PC1)-8.

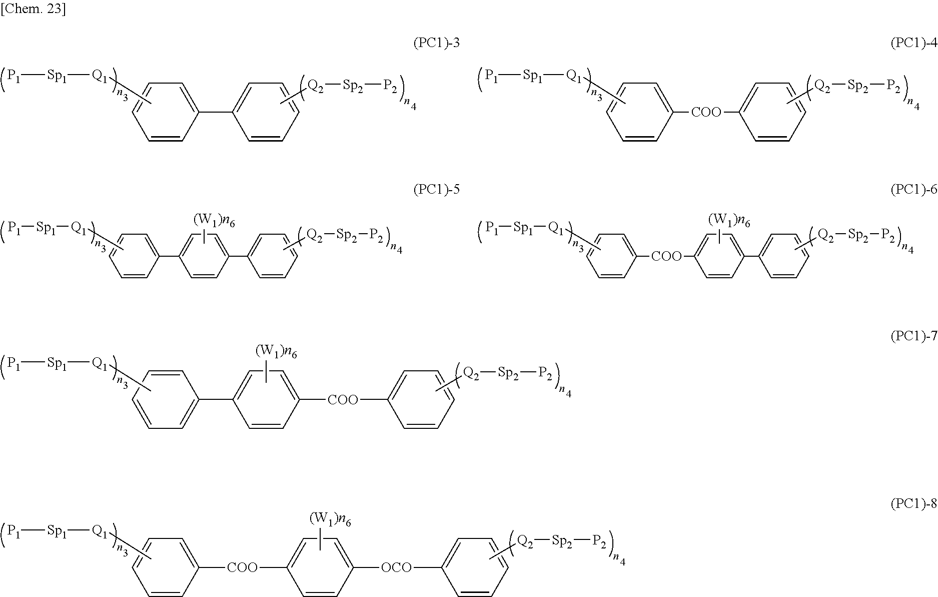

(in General Formulae (PC1)-3 to (PC1)-8, W₁'s each independently represent F, CF₃, OCF₃, CH₃, OCH₃, an alkyl group having 2 to 5 carbon atoms, an alkoxy group having 2 to 5 carbon atoms, an alkenyl group having 2 to 5 carbon atoms, COOW₂, OCOW₂, or OCOOW₂. (where W₂ represents a straight-chain or branched-chain alkyl group having 1 to 10 carbon atoms or an alkenyl group having 2 to 5 carbon atoms; and n₃, n₄, and n₆ are each independently 0, 1, 2, 3, or 4)

It is preferable that Sp₁, Sp₂, Q₁, and Q₂ in General Formulae (PC1)-3 to (PC1)-8 are all single bonds; n₃+n₄ is 3 to 6; P₁ and P₂ are represented by General Formula (PC1-c); W₁ is F, CF₃, OCF₃, CH₃, or OCH₃; and n₆ is 1 or more.

It is also preferable that MG in General Formula (PC1) is a disc-shaped liquid crystal compound represented by General Formula (PC1)-9.

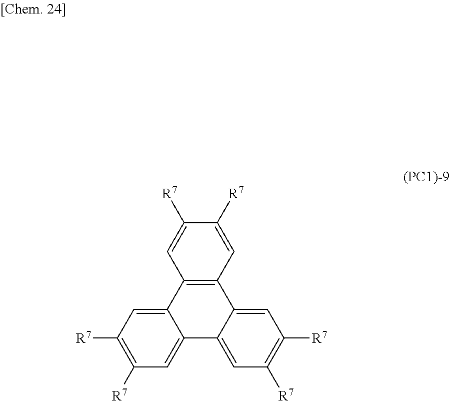

(in General Formula (PC1)-9, R⁷'s each independently represent P₁—Sp₁-Q₁ or a substituent represented by General Formula (PC1-e).

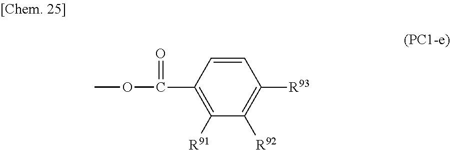

(where P₁, Sp₁, and Q₁ represent the same things as those described in General Formula (PC1), respectively; R⁹¹ and R⁹² each independently represent a hydrogen atom, a halogen atom, or a methyl group; and R⁹³ represents an alkoxy group having 1 to 20 carbon atoms and at least one hydrogen atom of the alkoxy group may be substituted by a substituent represented by any one of General Formulae (PC1-a) to (PC1-d) above)

The amount of polymerizable compound to be used is preferably 0.1% to 2.0% by mass.

The liquid crystal composition according to the present invention may include one or more types of antioxidants and one or more types of UV absorbers in order to enhance the stability of the liquid crystal composition.

A liquid crystal display element including the liquid crystal composition according to the present invention advantageously realizes both high-speed response and suppression of faulty display. The liquid crystal display element may be advantageously used, in particular, as a liquid crystal display element for active-matrix driving and may be used as a liquid crystal display element for TN mode, OCB mode, IPS mode, FFS mode, or VA-IPS mode.

A polymer-stabilized (PS)-mode liquid crystal display element may be prepared using the liquid crystal composition according to the present invention that includes the above-described polymerizable compound. Specifically, the polymer-stabilized (PS)-mode liquid crystal display element may be prepared by holding a liquid crystal composition including a polymerizable compound between two substrates and polymerizing the polymerizable compound included in the liquid crystal composition by using energy such as ultraviolet radiation under application of a voltage or without application of a voltage. In the liquid crystal display element, the alignment state of liquid crystal molecules can be retained by polymerization of the polymerizable compound, which enhances the stability of the alignment state. This may also improve response speed.

### EXAMPLES

The present invention is described below further in detail with reference to examples. However, the present invention is not limited by the examples. Note that, when referring to compositions in Examples and Comparative Examples, “%” always denotes “% by mass”.

The physical properties of a liquid crystal composition are represented as follows:

T_{N-I}: Nematic phase-isotropic liquid phase transition temperature (° C.)

T-n: Lower limit temperature of nematic phase (° C.)

Σ⊥: Dielectric constant in a direction perpendicular to the longitudinal direction of molecules at 25° C.

Δ∈: Dielectric anisotropy at 25° C.

n0: Refractive index for ordinary light at 25° C.

Δn: Refractive-index anisotropy at 25° C.

Vth: Voltage (V) applied to a cell having a thickness of 6 μm when transmittance is changed by 10% due to application of a rectangular wave having a frequency 1 KHz at 25° C.

η₂₀: Bulk viscosity at 20° C. (mPa·s)

γ₁: Rotational viscosity (mPa·s)

The following abbreviations are used to describe compounds.

TABLE 1

| | |
|---|---|
| n (numeral) at the end | CₙH₂ₙ₊₁— |
| -2- | —CH₂CH₂— |
| —1O— | —CH₂O— |
| —O1— | —OCH₂— |
| —V— | —CO— |
| —VO— | —COO— |
| —CFFO— | —CF₂O— |
| —F | —F |
| —Cl | —Cl |
| —CN | —C≡N |
| —OCFFF | —OCF₃ |
| —CFFF | 0 |
| —OCFF | —OCHF₂ |
| —On | —OCₙH₂ₙ₊₁ |
| -T- | —C≡C— |
| ndm- | CₙH₂ₙ₊₁—HC═CH—(CH₂)ₘ₋₁— |
| -ndm | —(CH₂)ₙ₋₁—HC═CH—CₘH₂ₘ₊₁ |
| ndmO— | CₙH₂ₙ₊₁—HC═CH—(CH₂)ₘ₋₁—O— |
| —Ondm | —O—(CH₂)ₙ₋₁—HC═CH—CₘH₂ₘ₊₁ |

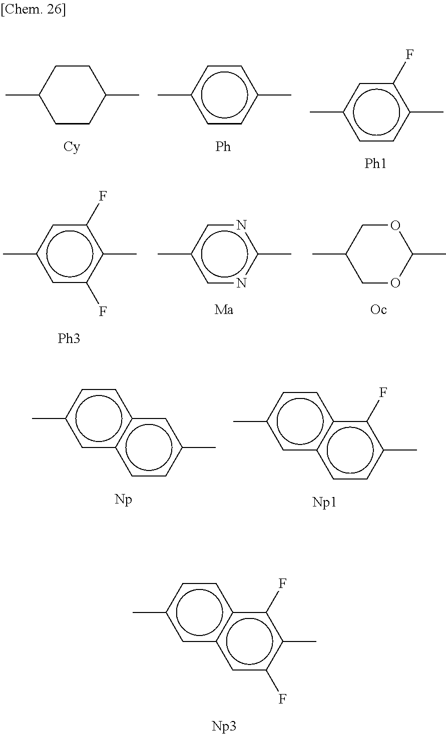

### Example 1

The prepared liquid crystal composition and the physical properties of the liquid crystal composition are shown below.

TABLE 2

| 1d1-Cy-Cy-2 | 10.0% | |
|---|---|---|
| 0d3-Cy-Cy-3 | 10.0% | |
| 1d1-Cy-Cy-3 | 10.0% | |
| 0d1-Cy-Cy-1d1 | 10.0% | |
| 3-Cy-Cy-Ph-1 | 10.0% | |
| 1-Ph—Ph1—Ph-3d0 | 10.0% | |
| 3-Ph—Ph—CFFO—Np3—F | 10.0% | |
| 3-Cy-Ph—Ph3—OCFFF | 10.0% | |
| 3-Ph—Ph1—Ph3—OCFFF | 5.0% | |
| 3-Cy-Cy-Ph1—Ph1—F | 5.0% | |
| 3-Ph3—O1—Ph—Np3—F | 10.0% | |
| Tni | 88.6 | |
| T-n | −33 | |
| Vth | 1.45 | V |
| γ₁ | 85 | mPa · s |
| ε⊥ | 3.2 | |
| Δε | 9.0 | |
| no | 1.498 | |
| Δn | 0.132 | |
| η 20 | 17.5 | mPa · s |

### Comparative Example 1

The prepared liquid crystal composition and the physical properties of the liquid crystal composition are shown below.

TABLE 3

| 1d1-Cy-Cy-2 | 10.0% | |
|---|---|---|
| 0d3-Cy-Cy-3 | 10.0% | |
| 1d1-Cy-Cy-3 | 10.0% | |
| 0d1-Cy-Cy-1d1 | 10.0% | |
| 3-Cy-Cy-Ph-1 | 10.0% | |
| 1-Ph—Ph1—Ph-3d0 | 10.0% | |
| 3-Ph—Ph1—Np3—F | 10.0% | |
| 3-Cy-Ph—Ph3—OCFFF | 10.0% | |
| 3-Ph—Ph1—Ph3—OCFFF | 5.0% | |
| 3-Cy-Cy-Ph1—Ph1—F | 5.0% | |
| 3-Ph3—1O—Ph—Np3—F | 10.0% | |
| Tni | 90.1 | |
| T-n | −30 | |
| Vth | 1.53 | V |
| γ₁ | 98 | mPa · s |
| ε⊥ | 3.0 | |
| Δε | 8.0 | |
| no | 1.500 | |
| Δn | 0.138 | |
| η 20 | 20.6 | mPa · s |

This liquid crystal composition is a liquid crystal composition that does not include the compound represented by General Formula (LC0-1) or General Formula (LC0-2) according to the present invention. The prepared liquid crystal composition in Example 1 had a far lower viscosity than that prepared in Comparative Example 1 and had a low γ₁, which proves the superiority of the combination according to the present invention.

### Example 2

The prepared liquid crystal composition and the physical properties of the liquid crystal composition are shown below.

TABLE 4

| 0d1-Cy-Cy-3 | 10.0% | |
|---|---|---|
| 1d1-Cy-Cy-2 | 10.0% | |
| 0d3-Cy-Cy-3 | 10.0% | |
| 1d1-Cy-Cy-1d1 | 10.0% | |
| 0d3-Cy-Cy-3d0 | 10.0% | |
| 0d1-Cy-Ph—O4 | 5.0% | |
| 5-Ph—Ph-1 | 5.0% | |
| 0d3-Ph—Ph-3d0 | 5.0% | |
| 2-Ph—Ph1—Ph-3d1 | 10.0% | |
| 3-Cy-Cy-CFFO—Np3—F | 10.0% | |
| 3-Ph—Ph—CFFO—Np3—F | 10.0% | |
| 3-Cy-Ph1—Ph3—O1—Ph3—OCFFF | 5.0% | |
| Tni | 76 | |
| T-n | −34 | |
| Vth | 1.91 | V |
| γ₁ | 63 | mPa · s |
| ε⊥ | 2.6 | |
| Δε | 5.8 | |
| no | 1.492 | |
| Δn | 0.114 | |
| η 20 | 11.8 | mPa · s |

### Example 3

The prepared liquid crystal composition and the physical properties of the liquid crystal composition are shown below.

TABLE 5

| 0d1-Cy-Cy-3 | 10.0% | |
|---|---|---|
| 1d1-Cy-Cy-2 | 10.0% | |
| 0d3-Cy-Cy-3 | 10.0% | |
| 1d1-Cy-Cy-1d1 | 10.0% | |
| 1-Ph—Ph1—Ph-3d0 | 5.0% | |
| 2-Ph—Ph1—Ph-3d1 | 5.0% | |
| 3-Ph1—Np3—F | 5.0% | |
| 3-Ph—Ph1—Np3—F | 5.0% | |
| 3-Cy-Cy-CFFO—Np3—F | 5.0% | |
| 3-Cy-Ph—Ph3—OCFFF | 5.0% | |
| 3-Ph—Ph1—Ph3—OCFFF | 5.0% | |
| 3-Ph—Ph3—O1—Ph3—F | 5.0% | |
| 3-Ph3—O1—Ph—Np3—F | 5.0% | |
| 3-Cy-Cy-Ph3—O1—Ph3—F | 10.0% | |
| 3-Cy-Ph1—Ph3—O1—Ph3—OCFFF | 5.0% | |
| Tni | 80.9 | |
| T-n | 34 | |
| Vth | 1.36 | V |
| γ₁ | 86 | mPa · s |
| ε⊥ | 3.5 | |
| Δε | 8.6 | |
| no | 1.496 | |
| Δn | 0.125 | |
| η 20 | 17.9 | mPa · s |

### Example 4

The prepared liquid crystal composition and the physical properties of the liquid crystal composition are shown below.

TABLE 6

| 0d3-Cy-Cy-3 | 10.0% | |
|---|---|---|
| 1d1-Cy-Cy-3 | 10.0% | |
| 0d1-Cy-Cy-1d1 | 10.0% | |
| 5-Ph—Ph-1 | 5.0% | |
| 3-Cy-Cy-Ph-1 | 5.0% | |
| 1-Ph—Ph1—Ph-3d0 | 5.0% | |
| 2-Ph—Ph1—Ph-3d1 | 5.0% | |
| 3-Ph1—Np3—F | 5.0% | |
| 3-Ph—Ph1—Np3—F | 5.0% | |
| 3-Cy-Cy-CFFO—Np3—F | 5.0% | |
| 3-Ph—Ph—CFFO—Np3—F | 5.0% | |
| 3-Cy-Ph—Ph3—OCFFF | 5.0% | |
| 3-Ph—Ph1—Ph3—OCFFF | 5.0% | |
| 3-Cy-Cy-Ph1—Ph1—F | 5.0% | |
| 3-Ph—Ph3—O1—Ph3—F | 5.0% | |
| 3-Ph3—O1—Ph—Np3—F | 5.0% | |
| 3-Cy-Cy-Ph3—O1—Ph3—F | 5.0% | |
| Tni | 82.5 | |
| T-n | −35 | |
| Vth | 1.31 | V |
| γ₁ | 91 | mPa · s |
| ε⊥ | 3.6 | |
| Δε | 9.8 | |
| no | 1.499 | |
| Δn | 0.137 | |
| η 20 | 19.9 | mPa · s |

### Example 5

The prepared liquid crystal composition and the physical properties of the liquid crystal composition are shown below.

TABLE 7

| 1d1-Cy-Cy-2 | 10.0% | |
|---|---|---|
| 0d3-Cy-Cy-3 | 10.0% | |
| 1d1-Cy-Cy-3 | 10.0% | |
| 0d1-Cy-Cy-1d1 | 10.0% | |
| 3-Cy-Cy-2 | 5.0% | |
| 0d1-Cy-Cy-Ph-1 | 5.0% | |
| 1-Ph—Ph1—Ph-3d0 | 5.0% | |
| 2-Ph—Ph1—Ph-3d1 | 5.0% | |
| 3-Ph1—Np3—F | 5.0% | |
| 3-Ph—Ph1—Np3—F | 5.0% | |
| 3-Cy-Cy-CFFO—Np3—F | 5.0% | |
| 3-Ph—Ph—CFFO—Np3—F | 5.0% | |
| 3-Cy-Ph3—O1—Ph3—Ph—OCFFF | 5.0% | |
| 3-Ph3—O1-Cy-Ph3—Ph3—F | 5.0% | |
| 3-Cy-Cy-CFFO—Ph3—F | 5.0% | |
| 3-Cy-Ph1—Ph3—CFFO—Ph3—F | 5.0% | |
| Tni | 81.6 | |
| T-n | −34 | |
| Vth | 1.44 | V |
| γ₁ | 80 | mPa · s |
| ε⊥ | 3.2 | |
| Δε | 9.0 | |
| no | 1.491 | |
| Δn | 0.113 | |
| η 20 | 16.0 | mPa · s |

### Example 6

The prepared liquid crystal composition and the physical properties of the liquid crystal composition are shown below.

TABLE 8

| 0d3-Cy-Cy-3 | 10.0% | |
|---|---|---|
| 1d1-Cy-Cy-3 | 10.0% | |
| 0d1-Cy-Cy-1d1 | 10.0% | |
| 3-Cy-Cy-2 | 5.0% | |
| 1-Ph—Ph1—Ph-3d0 | 5.0% | |
| 3-Ph—Ph1—Np3—F | 5.0% | |
| 3-Cy-Cy-CFFO—Np3—F | 5.0% | |
| 3-Ph—Ph—CFFO—Np3—F | 5.0% | |
| 3-Ph3—O1—Ph—Np3—F | 5.0% | |
| 3-Cy-Ph3—O1—Ph3—F | 5.0% | |
| 3-Cy-Ph3—O1—Ph—OCFFF | 5.0% | |
| 3-Ph—Ph3—O1—Ph—OCFFF | 5.0% | |
| 3-Cy-Ph1—Ph3—O1—Ph3—F | 5.0% | |
| 3-Cy-Ph1—Ph3—O1—Ph—OCFFF | 5.0% | |
| 3-Ph—Ph1—Ph3—O1—Ph—OCFFF | 5.0% | |
| 3-Cy-Cy-CFFO—Ph3—F | 5.0% | |
| 3-Cy-Ph1—Ph3—CFFO—Ph3—F | 5.0% | |
| Tni | 78.9 | |
| T-n | −36 | |
| Vth | 1.29 | V |
| γ₁ | 82 | mPa · s |
| ε⊥ | 4.4 | |
| Δε | 10.8 | |
| no | 1.495 | |
| Δn | 0.119 | |
| η 20 | 16.6 | mPa · s |

### Example 7

The prepared liquid crystal composition and the physical properties of the liquid crystal composition are shown below.

TABLE 9

| 1d1-Cy-Cy-2 | 10.0% | |
|---|---|---|
| 1d1-Cy-Cy-3 | 10.0% | |
| 0d1-Cy-Cy-1d1 | 10.0% | |
| 3-Cy-Cy-2 | 5.0% | |
| 0d1-Cy-Cy-Ph-1 | 5.0% | |
| 2-Ph—Ph1—Ph-3d1 | 5.0% | |
| 3-Ph1—Np3—F | 5.0% | |
| 3-Cy-Cy-CFFO—Np3—F | 5.0% | |
| 3-Ph—Ph—CFFO—Np3—F | 5.0% | |
| 3-Ph3—O1—Ph—Np3—F | 5.0% | |
| 3-Ph—Ph3—O1—Ph3—F | 5.0% | |
| 3-Cy-Ph1—Ph3—O1—Ph3—F | 5.0% | |
| 3-Cy-Ph1—Ph3—O1—Ph—OCFFF | 5.0% | |
| 3-Ph—Ph1—Ph3—O1—Ph—OCFFF | 5.0% | |
| 3-Cy-Ph3—O1—Ph3—Ph—OCFFF | 5.0% | |
| 3-Ph3—O1-Cy-Ph3—Ph3—F | 5.0% | |
| 3-Cy-Cy-CFFO—Ph3—F | 5.0% | |
| Tni | 78.4 | |
| T-n | −34 | |
| Vth | 1.26 | V |
| γ₁ | 86 | mPa · s |
| ε⊥ | 4.2 | |
| Δε | 11.2 | |
| no | 1.490 | |
| Δn | 0.112 | |
| η 20 | 17.6 | mPa · s |

### Example 8

The prepared liquid crystal composition and the physical properties of the liquid crystal composition are shown below.

TABLE 10

| 1d1-Cy-Cy-2 | 10.0% | |
|---|---|---|
| 0d3-Cy-Cy-3 | 10.0% | |
| 1d1-Cy-Cy-3 | 10.0% | |
| 3-Cy-Cy-2 | 5.0% | |
| 0d1-Cy-Cy-Ph-1 | 10.0% | |
| 2-Ph—Ph1—Ph-3d1 | 5.0% | |
| 3-Ph1—Np3—F | 5.0% | |
| 3-Ph—Ph1—Np3—F | 5.0% | |
| 3-Ph3—O1—Ph—Np3—F | 5.0% | |
| 3-Cy-Ph3—O1—Ph3—F | 5.0% | |
| 3-Cy-Ph3—O1—Ph—OCFFF | 5.0% | |
| 3-Ph—Ph3—O1—Ph—OCFFF | 5.0% | |
| 3-Ph—Ph1—Ph3—O1—Ph—OCFFF | 5.0% | |
| 3-Cy-Ph3—O1—Ph3—Ph—OCFFF | 5.0% | |
| 3-Cy-Cy-CFFO—Ph3—F | 5.0% | |
| 3-Cy-Ph1—Ph3—CFFO—Ph3—F | 5.0% | |
| Tni | 71.3 | |
| T-n | −35 | |
| Vth | 1.47 | V |
| γ₁ | 73 | mPa · s |
| ε⊥ | 3.2 | |
| Δε | 8.8 | |
| no | 1.402 | |
| Δn | 0.115 | |
| η 20 | 13.9 | mPa · s |

### Example 9

The prepared liquid crystal composition and the physical properties of the liquid crystal composition are shown below.

TABLE 11

| 1d1-Cy-Cy-2 | 10.0% | |
|---|---|---|
| 0d3-Cy-Cy-3 | 10.0% | |
| 1d1-Cy-Cy-3 | 10.0% | |
| 0d1-Cy-Cy-1d1 | 10.0% | |
| 2-Cy-Cy-Ph-1 | 5.0% | |
| 2-Ph—Ph1—Ph-5 | 5.0% | |
| 3-Cy-Cy-CFFO—Np3—F | 5.0% | |
| 3-Ph—Ph—CFFO—Np3—F | 5.0% | |
| 3-Ph3—O1—Ph—Np3—F | 5.0% | |
| 3-Cy-Ph—Ph3—F | 5.0% | |
| 3-Cy-Cy-Ph3—OCFFF | 5.0% | |
| 0d3-Ph—Ph—Ph3—F | 5.0% | |
| 3-Cy-Ph3—O1—Ph3—F | 5.0% | |
| 3-Cy-Ph3—O1—Ph—OCFFF | 5.0% | |
| 3-Cy-Ph1—Ph3—O1—Ph—OCFFF | 5.0% | |
| 3-Cy-Cy-CFFO—Ph3—F | 5.0% | |
| Tni | 75.5 | |
| T-n | −34 | |
| Vth | 1.53 | V |
| γ₁ | 73 | mPa · s |
| ε⊥ | 3.1 | |
| Δε | 7.9 | |
| no | 1.430 | |
| Δn | 0.104 | |
| η 20 | 13.8 | mPa · s |

### Example 10

The prepared liquid crystal composition and the physical properties of the liquid crystal composition are shown below.

TABLE 12

| 1d1-Cy-Cy-2 | 10.0% | |
|---|---|---|
| 0d3-Cy-Cy-3 | 10.0% | |
| 1d1-Cy-Cy-3 | 10.0% | |
| 0d1-Cy-Cy-1d1 | 10.0% | |
| 2-Cy-Cy-Ph-1 | 5.0% | |
| 2-Ph—Ph1—Ph-5 | 5.0% | |
| 3-Cy-Cy-CFFO—Np3—F | 5.0% | |
| 3-Ph—Ph—CFFO—Np3—F | 5.0% | |
| 3-Ph3—O1—Ph—Np3—F | 5.0% | |
| 3-Cy-Ph—Ph3—F | 5.0% | |
| 3-Cy-Cy—Ph3—OCFFF | 5.0% | |
| 0d3-Ph—Ph—Ph3—F | 5.0% | |
| 3-Ph—Ph3—O1—Ph3—F | 5.0% | |
| 3-Ph—Ph3—O1—Ph—OCFFF | 5.0% | |
| 3-Cy-Ph1—Ph3—O1—Ph3—F | 5.0% | |
| 3-Cy-Ph1—Ph3—CFFO—Ph3—F | 5.0% | |
| Tni | 73.1 | |
| T-n | −33 | |
| Vth | 1.35 | V |
| γ₁ | 78 | mPa · s |
| ε⊥ | 3.6 | |
| Δε | 9.6 | |
| no | 1.401 | |
| Δn | 0.112 | |
| η 20 | 15.7 | mPa · s |

### Example 11

The prepared liquid crystal composition and the physical properties of the liquid crystal composition are shown below.

TABLE 13

| 0d3-Cy-Cy-3 | 10.0% | |
|---|---|---|
| 1d1-Cy-Cy-3 | 10.0% | |
| 0d1-Cy-Cy-1d1 | 5.0% | |
| 3-Ph1—Np3—F | 5.0% | |
| 3-Ph—Ph1—Np3—F | 5.0% | |
| 3-Ph3—O1—Ph—Np3—F | 5.0% | |
| 3-Cy-Ph—Ph3—F | 10.0% | |
| 3-Cy-Cy-Ph3—OCFFF | 10.0% | |
| 3-Cy-Ph3—O1—Ph—OCFFF | 5.0% | |
| 3-Ph—Ph3—O1—Ph—OCFFF | 5.0% | |
| 3-Cy-Ph1—Ph3—O1—Ph—OCFFF | 10.0% | |
| 3-Ph—Ph1—Ph3—O1—Ph—OCFFF | 10.0% | |
| 3-Cy-Cy-CFFO—Ph3—F | 10.0% | |
| Tni | 74.5 | |
| T-n | −32 | |
| Vth | 1.26 | V |
| γ₁ | 89 | mPa · s |
| ε⊥ | 4.4 | |
| Δε | 11.8 | |
| no | 1.496 | |
| Δn | 0.123 | |
| η 20 | 18.5 | mPa · s |

### Example 12

The prepared liquid crystal composition and the physical properties of the liquid crystal composition are shown below.

TABLE 14

| 1d1-Cy-Cy-2 | 10.0% | |
|---|---|---|
| 0d3-Cy-Cy-3 | 10.0% | |
| 1d1-Cy-Cy-3 | 10.0% | |
| 0d1-Cy-Cy-1d1 | 5.0% | |
| 2-Cy-Cy-Ph-1 | 5.0% | |
| 2-Ph—Ph1—Ph-5 | 5.0% | |
| 3-Cy-Cy-CFFO—Np3—F | 5.0% | |
| 3-Ph—Ph—CFFO—Np3—F | 5.0% | |
| 3-Ph3—O1—Ph—Np3—F | 5.0% | |
| 0d3-Ph—Ph—Ph3—F | 10.0% | |
| 3-Cy-Ph3—O1—Ph3—F | 5.0% | |
| 3-Ph—Ph3—O1—Ph3—F | 5.0% | |
| 3-Cy-Ph1—Ph3—O1—Ph3—F | 10.0% | |
| 3-Cy-Ph1—Ph3—CFFO—Ph3—F | 10.0% | |
| Tni | 74.5 | |
| T-n | −32 | |
| Vth | 1.26 | V |
| γ₁ | 89 | mPa · s |
| ε⊥ | 4.4 | |
| Δε | 11.8 | |
| no | 1.496 | |
| Δn | 0.123 | |
| η 20 | 18.5 | mPa · s |

As described above, the liquid crystal compositions prepared in Examples 2 to 12 had a low viscosity and a low γ₁, which proves the superiority of the combination according to the present invention.

### Example 13

A first substrate including a pair of transparent electrodes having a comb-like electrode structure formed thereon and a second substrate that did not include an electrode structure were prepared. A vertical alignment film was formed on each substrate. Then, a blank cell for IPS including the first substrate and the second substrate that were disposed at a gap interval of 4.0 microns was prepared. The liquid crystal composition prepared in Example 9 was injected into the blank cell. Thus, a liquid crystal display element was prepared. The electro-optical properties of the display element were measured. The voltage applied in order to change transmittance by 10% was 1.53 v. The speed of response to application of 5 v was 5.2 milliseconds. The speed of response to the switching-off of voltage was 13.4 seconds.

To 99% of the liquid crystal composition prepared in Example 3, 1% of the polymerizable compound represented by Formula (PC-1)-3-1 was added and dissolved uniformly to prepare a polymerizable liquid crystal composition CLC-A.

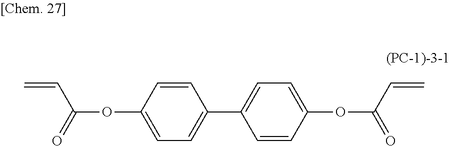 [SMILES: C=CC(=O)Oc1ccc(-c2ccc(OC(=O)C=C)cc2)cc1]

There were substantially no difference in physical properties between CLC-A and the liquid crystal composition prepared in Example 3.

CLC-A was held by the blank cell for IPS described above, and subsequently the liquid crystal cell was irradiated with ultraviolet radiation using a high-pressure mercury-vapor lamp with a filter that blocks ultraviolet radiation of 300 nm or less, which was interposed between the liquid crystal cell and the high-pressure mercury-vapor lamp, while a rectangular wave of 1.8 V was applied to the liquid crystal cell at a frequency of 1 KHz. The irradiation was performed for 600 seconds so that the irradiation intensity on the cell surface was 20 mW/cm² to polymerize the polymerizable compound included in the polymerizable liquid crystal composition. Thus, a vertical-alignment liquid crystal display element was prepared. The electro-optical properties of the display element were measured. The voltage applied in order to change transmittance by 10% was 1.61 v. The speed of response to application of 5 v was 5.2 milliseconds. The speed of response to the switching-off of voltage was 5.2 milliseconds, which was far faster than that of the above-described liquid crystal display element prepared using only the liquid crystal composition prepared in Example 9.

1. A liquid crystal composition having a positive dielectric anisotropy, the liquid crystal composition comprising:
one or more compounds selected from compounds represented by General Formula (LC0-1) and/or General Formula (LC0-2); and
one or more compounds selected from the group consisting of compounds represented by General Formulae (LC1) to (LC5), 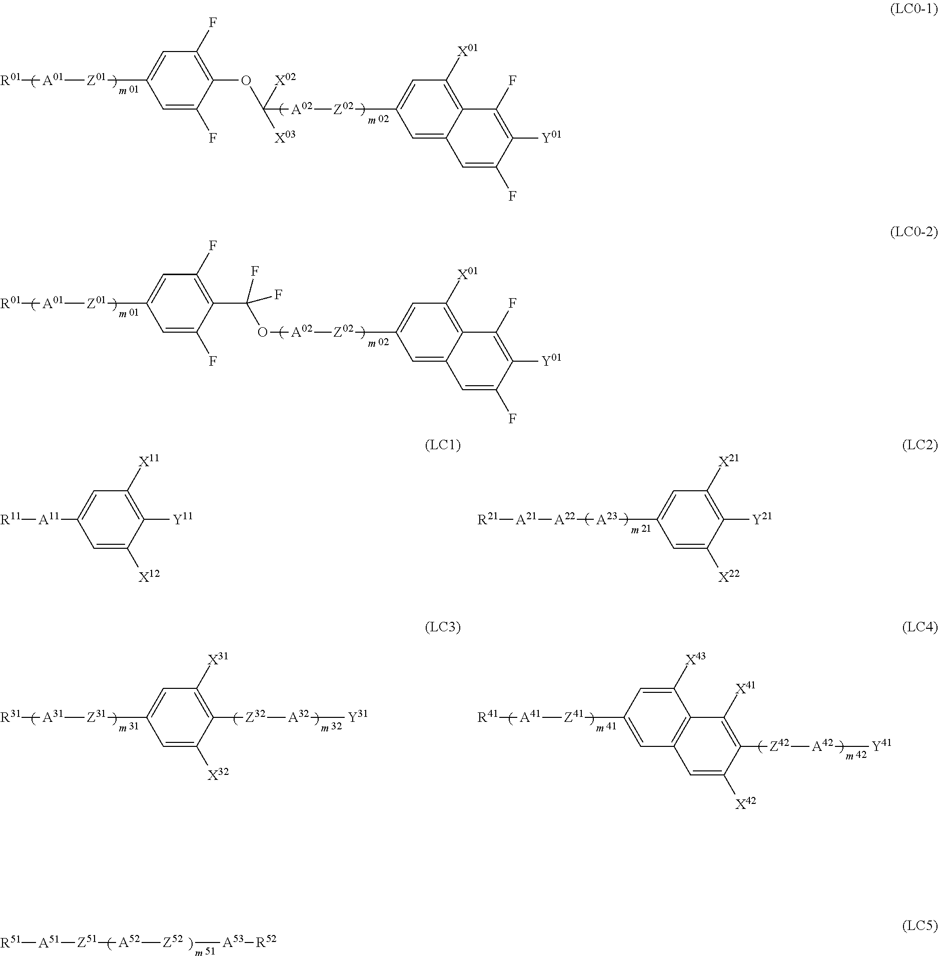
(wherein R⁰¹ to R⁴¹ each independently represent an alkyl group having a carbon number of 1 to 15; one or more —CH₂— of the alkyl group may be substituted by —O—, —CH═CH—, —CO—, —OCO—, —COO—, —C≡C—, —CF₂O—, or —OCF₂— so that an oxygen atom is not directly adjacent to another oxygen atom, one or more hydrogen atoms of the alkyl group may be substituted by a halogen; R⁵¹ and R⁵² each independently represent an alkyl group having a carbon number of 1 to 15, and one or more —CH₂— of the alkyl group may be substituted by —O—, —CH═CH—, —CO—, —OCO—, —COO—, or —C≡C— so that an oxygen atom is not directly adjacent to another oxygen atom; A⁰¹ to A⁴² each independently represent any one of the following structures: 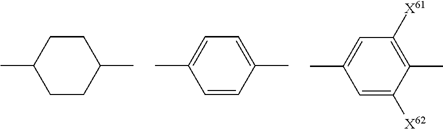
(wherein one or more —CH₂— in the cyclohexane ring may be substituted by —O— so that an oxygen atom is not directly adjacent to another oxygen atom; one or more —CH═ in the benzene ring may be substituted by —N═ so that a nitrogen atom is not directly adjacent to another nitrogen atom; and X⁶¹ and X⁶² each independently represent —H, —Cl, —F, —CF₃, or —OCF₃); A⁵¹ to A⁵³ each independently represent any one of the following structures: 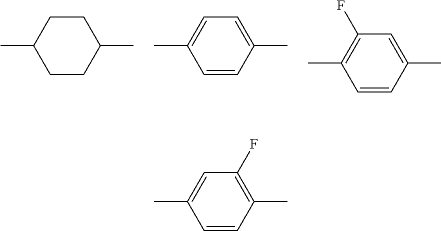
(wherein one or more —CH₂CH₂— in the cyclohexane ring may be substituted by —CH═CH—, —CF₂O—, or —OCF₂—; one or more —CH═ in the benzene ring may be substituted by —N═ so that a nitrogen atom is not directly adjacent to another nitrogen atom); X⁰¹ to X⁰³ each represent a hydrogen atom or a fluorine atom; X¹¹ to X⁴³ each independently represent —H, —Cl, —F, —CF₃, or —OCF₃; Y⁰¹ to Y⁴¹ each represent —Cl, —F, —CF₃, or —OCF₃; Z⁰¹ and Z⁰² each independently represent a single bond, —CH═CH—, —C≡C—, —CH₂CH₂—, —(CH₂)₄—, —OCH₂—, —CH₂O—, —OCF₂—, or —CF₂O—; Z³¹ to Z⁴² each independently represent a single bond, —CH═CH—, —C≡C—, —CH₂CH₂—, —(CH₂)₄—, —OCH₂—, —CH₂O—, —OCF₂—, or —CF₂O—; at least one of Z³¹ and Z³² is not a single bond; Z⁵¹ and Z⁵² each independently represent a single bond, —CH═CH—, —C≡C—, —CH₂CH₂—, —(CH₂)₄—, —OCH₂—, —CH₂O—, —OCF₂—, or —CF₂O—; m⁰¹ to m⁵¹ are each independently an integer of 0 to 3; m³¹+m³² and m⁴¹+m⁴² are each independently 1, 2, 3, or 4; m⁰¹+m⁰² is 1 or more, and one or more of rings represented by A⁰¹ and A⁰² are benzene rings; in the case where there are a plurality of A⁰¹'s, A⁰²'s, A⁰³'s, A²³'s, A³¹'s, A³²'s, A⁴¹'s, A⁴²'s, A⁵²'s, Z⁰¹'s, Z⁰²'s, Z³¹'s, Z³²'s, Z⁴¹'s, Z⁴²'s and/or Z⁵²'s, they may be all identical or different; and Z⁴¹'s each independently represent a single bond, —CH═CH—, —C≡C—, —CH₂CH₂—, or —(CH₂)₄— when m⁴² is 0).

2. The liquid crystal composition according to claim 1 including:
the one or more compounds selected from compounds represented by General Formula (LC0-1) and/or General Formula (LC0-2);
one or more compounds selected from the group consisting of compounds represented by General Formulae (LC1) to (LC4); and
one or more compounds selected from the group consisting of compounds represented by General Formula (LC5).

3. The liquid crystal composition according to claim 1 including:
one or more compounds selected from the group consisting of compounds represented by General Formulae (LC0-1-1) to (LC0-1-8) and/or the group consisting of compounds represented by General Formulae (LC0-2-1) to (LC0-2-4), 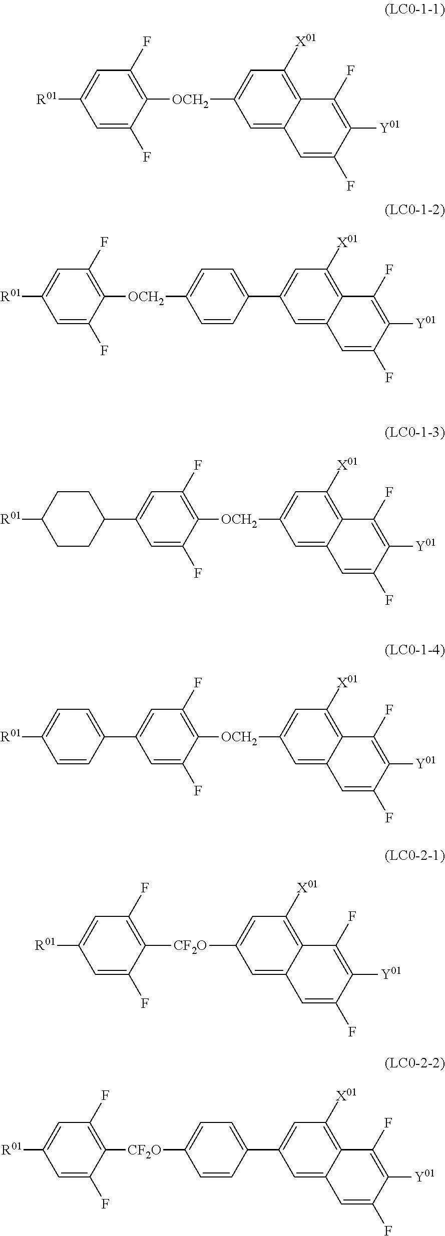 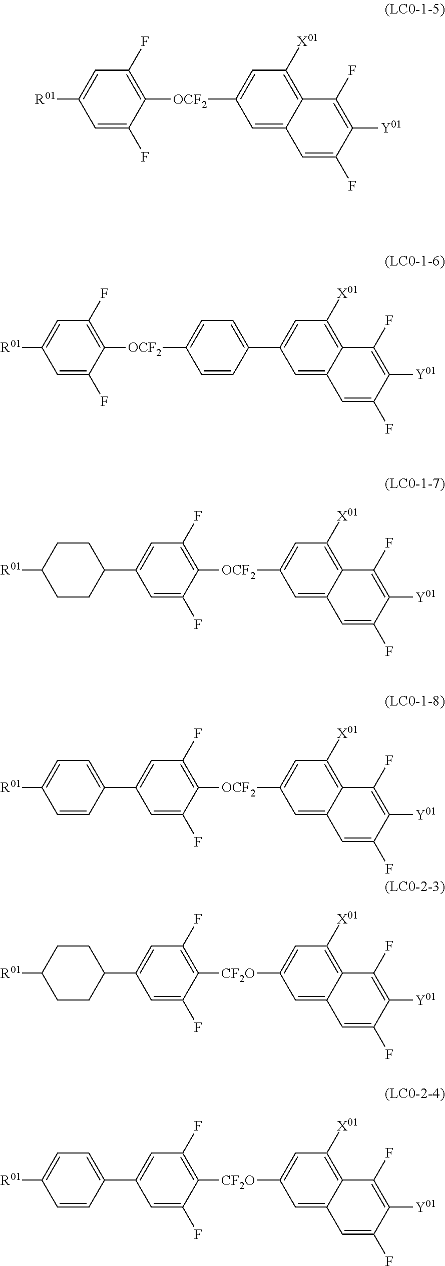
(wherein R⁰¹, X⁰¹, and Y⁰¹ represent the same things as those described in claim 1, respectively).

4. The liquid crystal composition according to claim 1 including:
the one or more compounds selected from compounds represented by General Formula (LC0-1) and/or General Formula (LC0-2); and
one or more compounds selected from the group consisting of compounds represented by General Formulae (LC2-1) to (LC2-8), 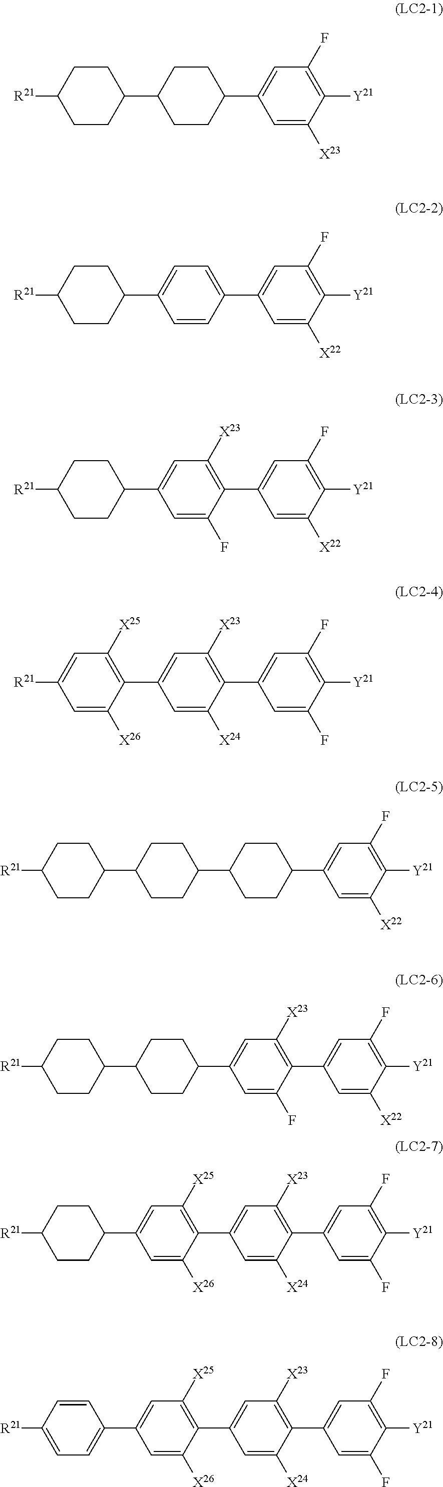
(wherein X²³, X²⁴, X²⁵, and X²⁶ each independently represent a hydrogen atom, Cl, F, CF₃, or OCF₃; and X²², R²¹, and Y²¹ represent the same things as those described in claim 1, respectively).

5. The liquid crystal composition according to claim 1 including:
the one or more compounds selected from compounds represented by General Formula (LC0-1) and/or General Formula (LC0-2); and
one or more compounds selected from compounds represented by General Formulae (LC3-1) to (LC3-22) and/or the group consisting of compounds represented by General Formulae (LC3-23) to (LC3-121), 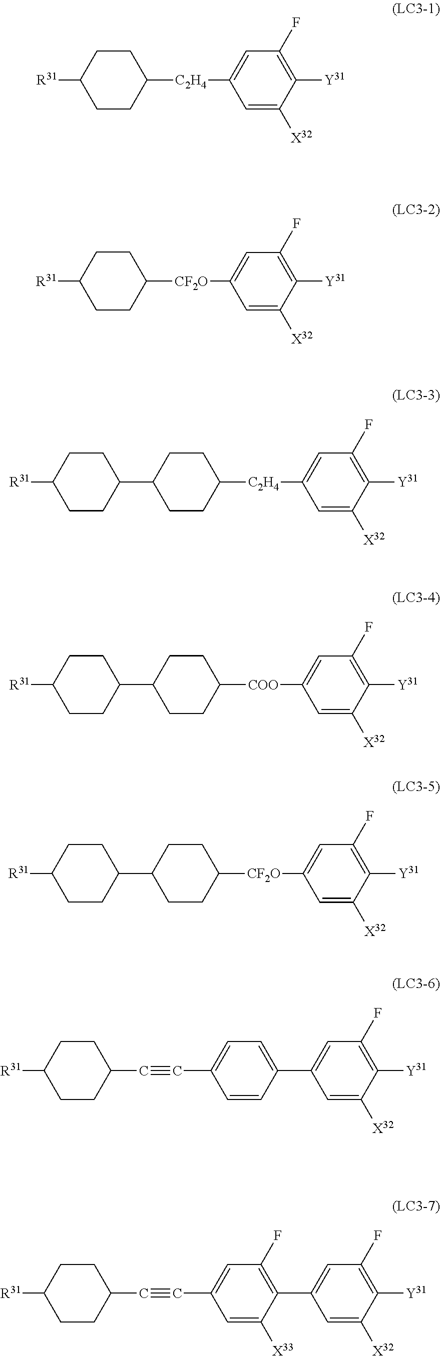 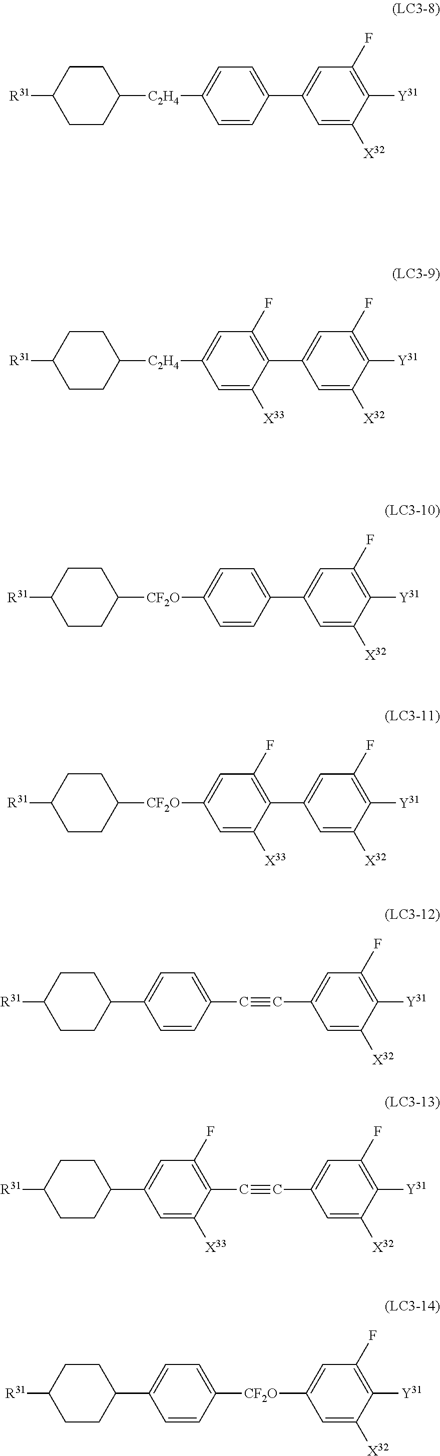 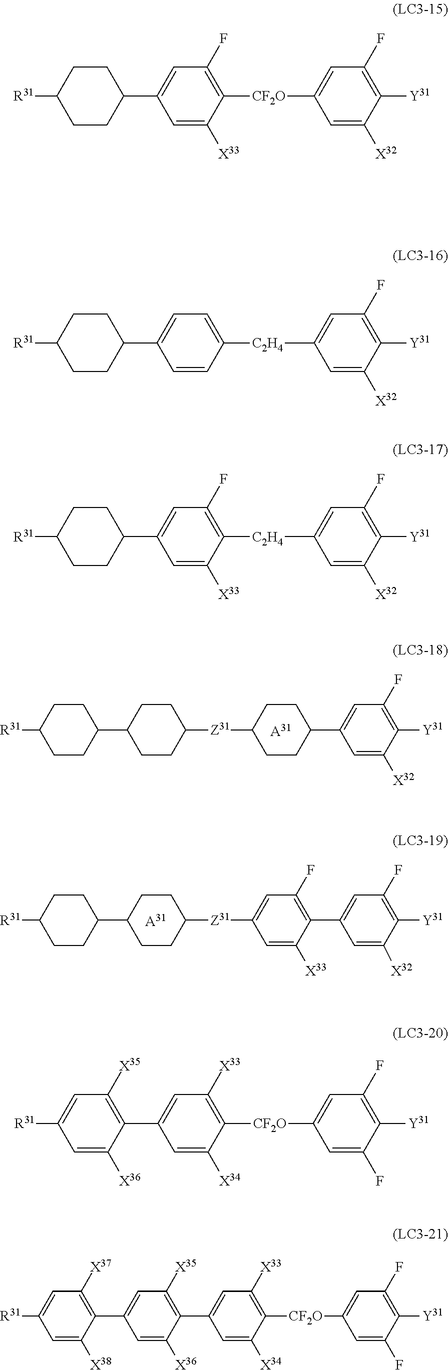 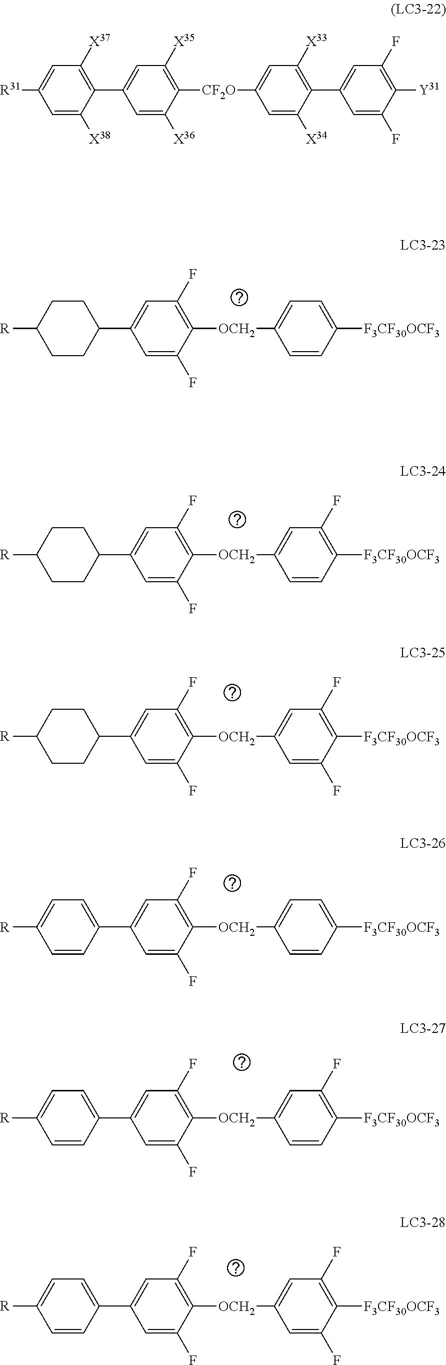 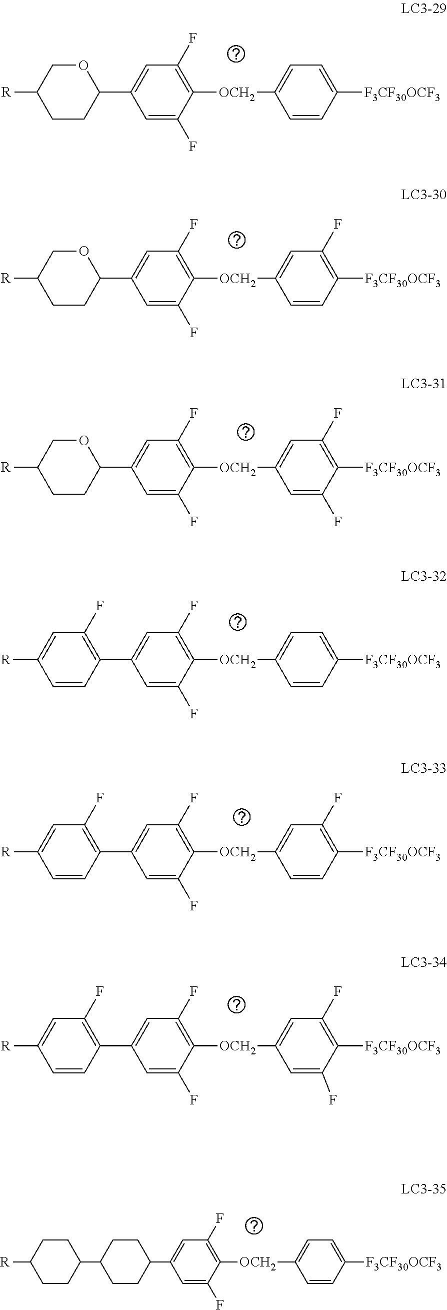 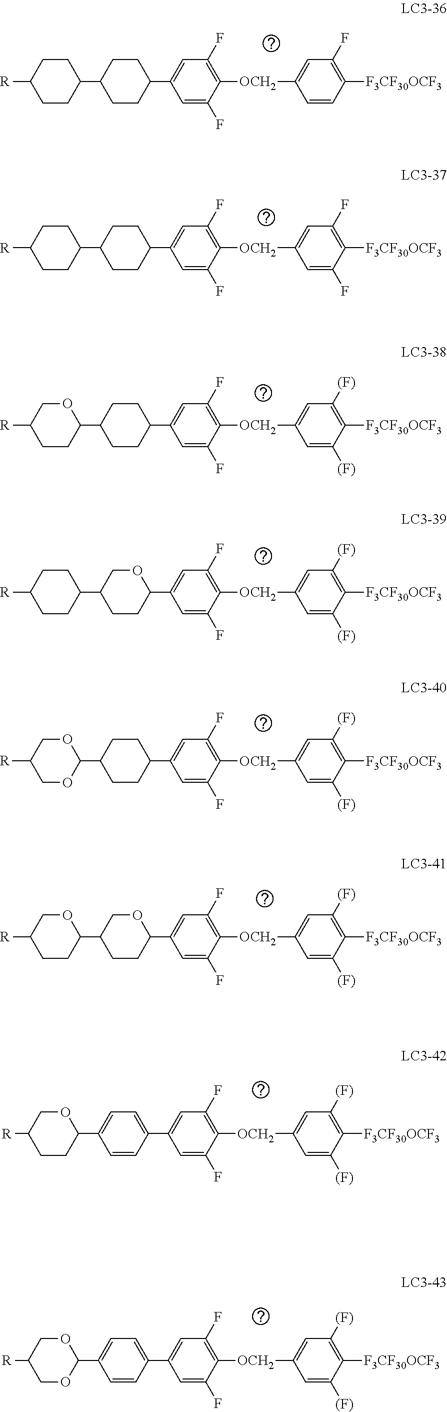 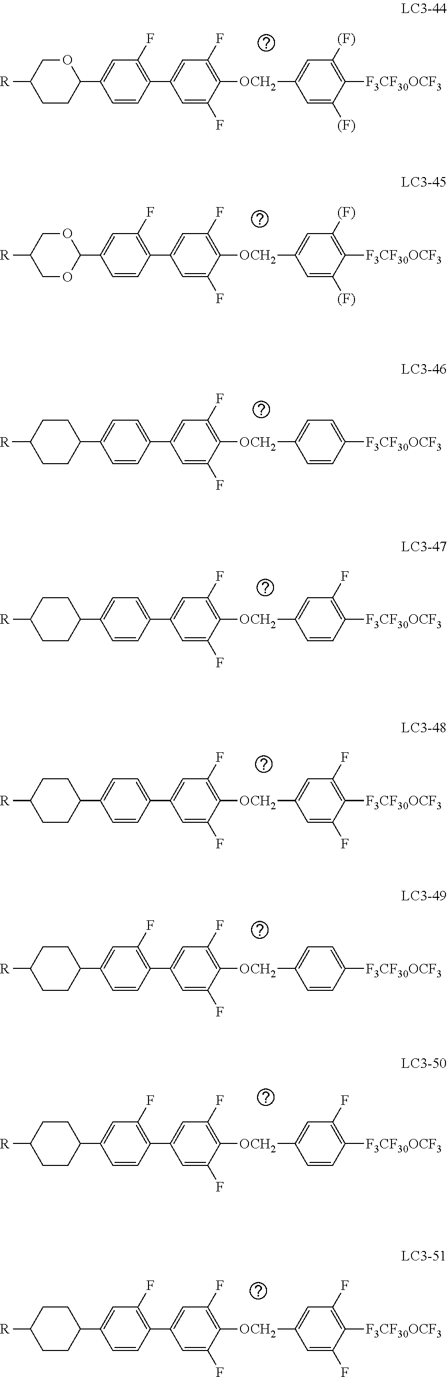 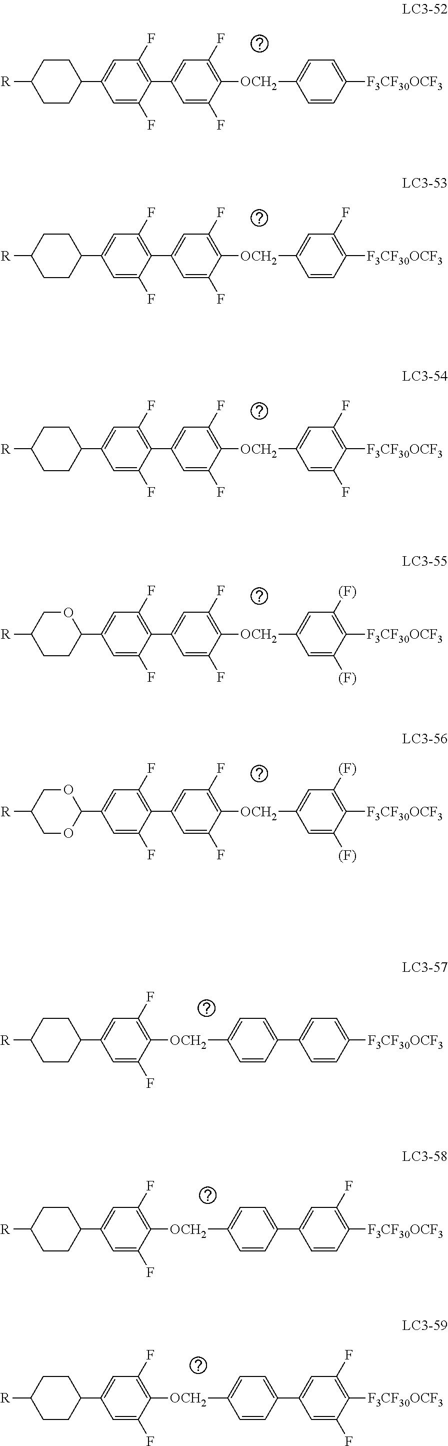 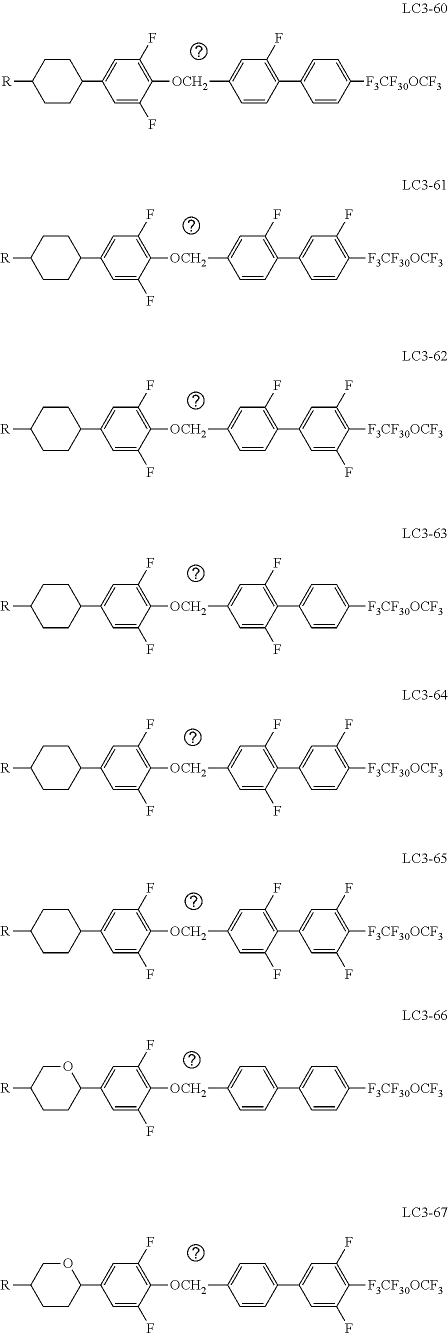 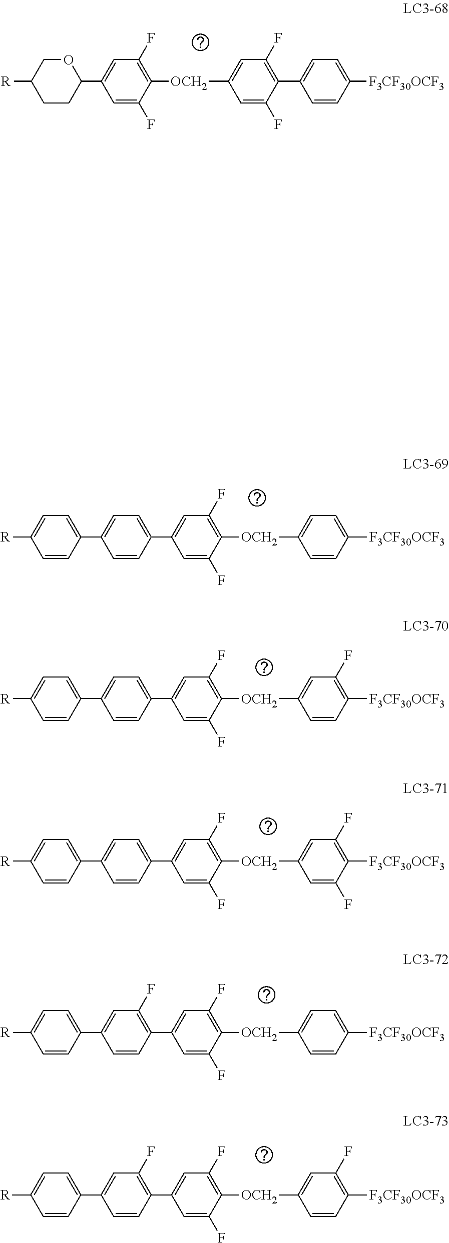 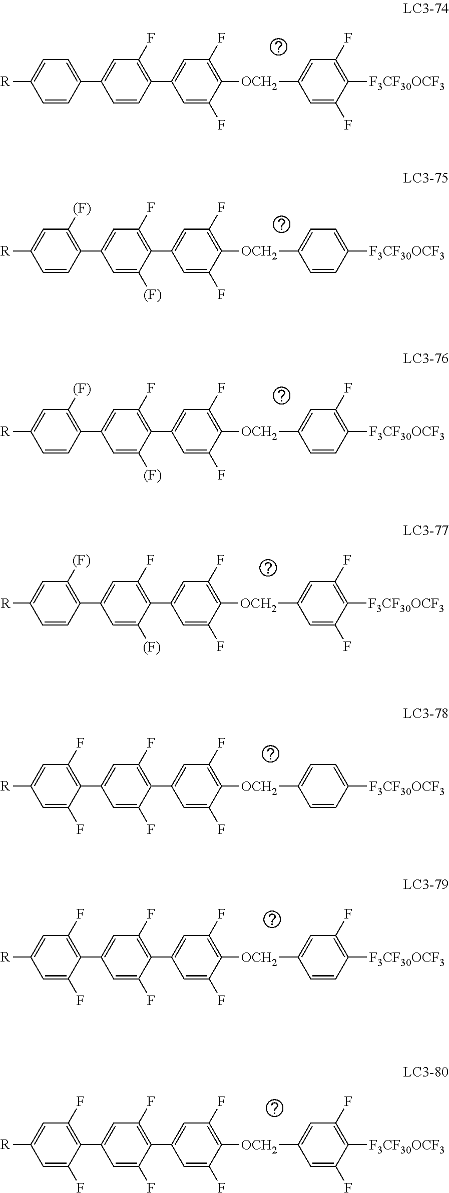 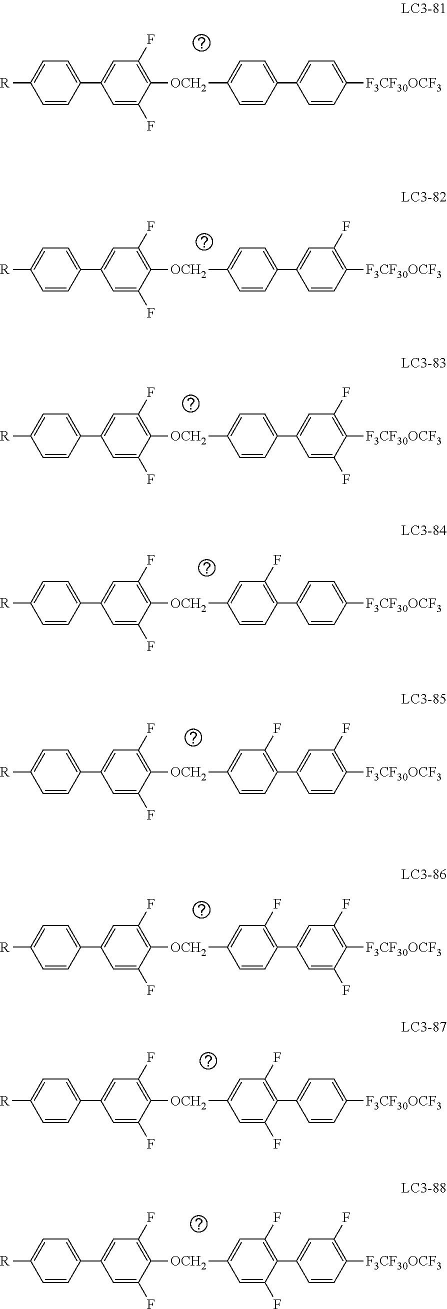 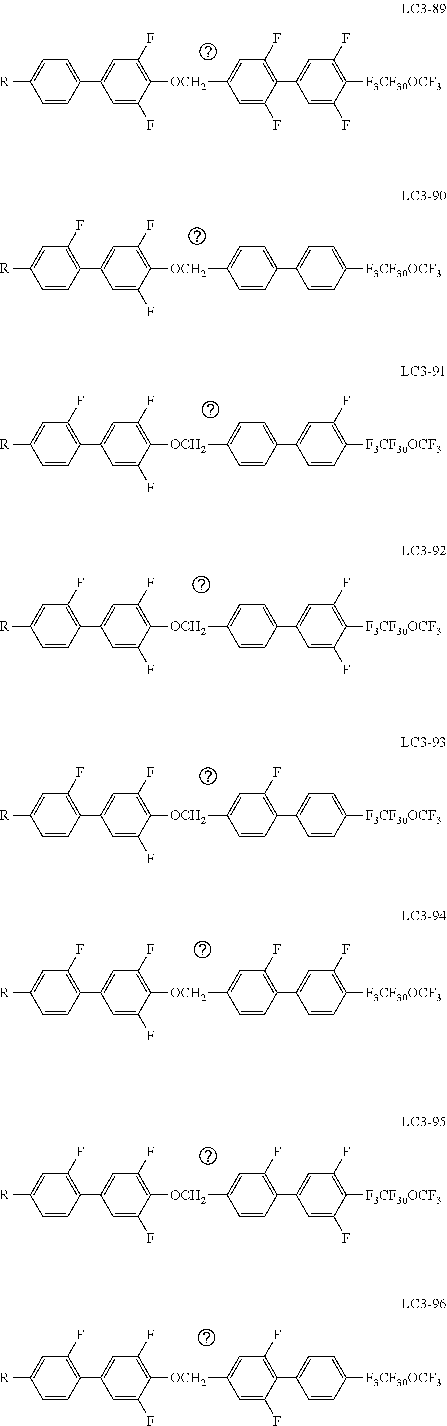 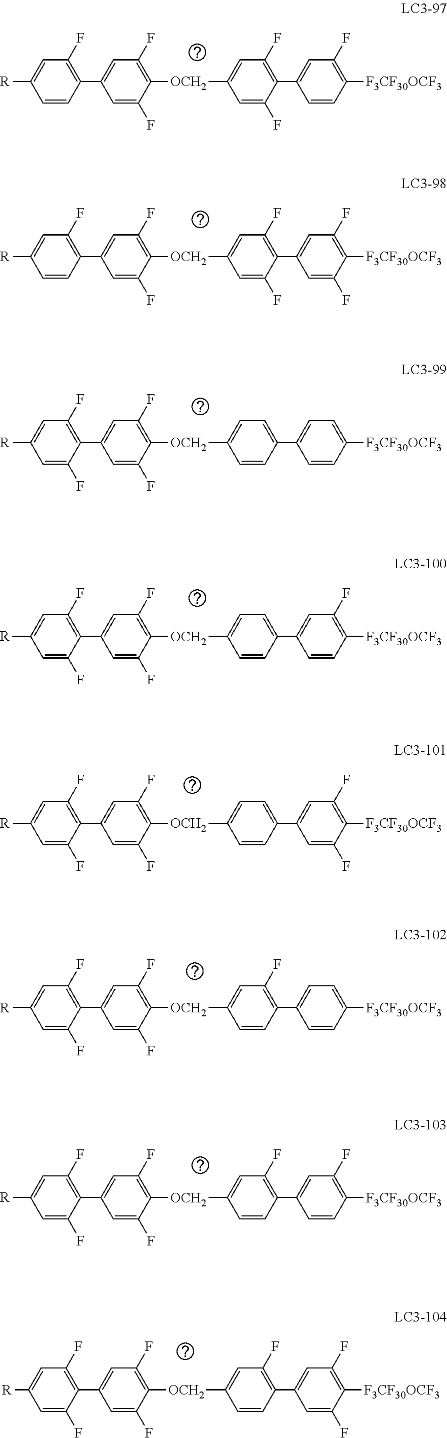 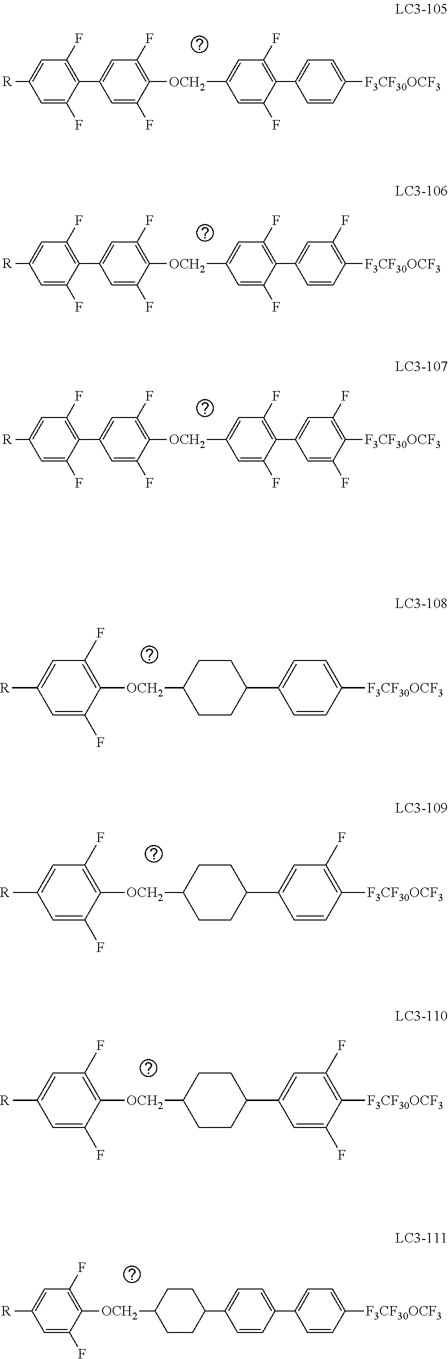 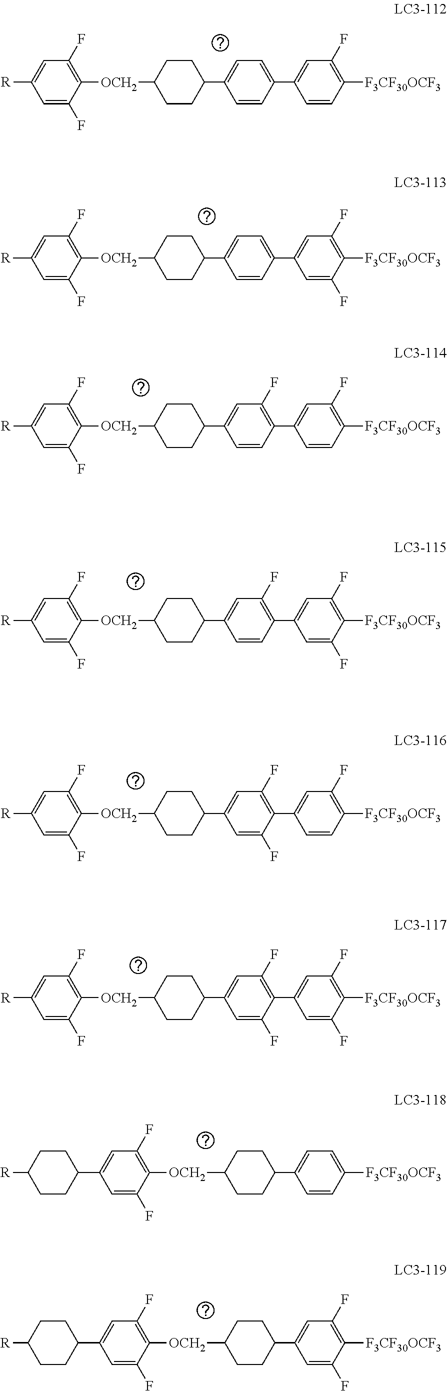 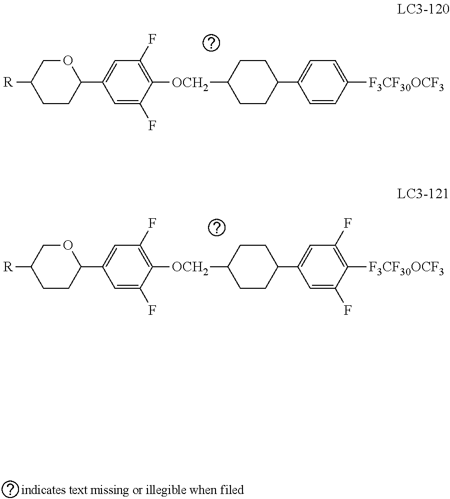
(wherein X³³, X³⁴, X³⁵, X³⁶, X³⁷, and X³⁸ each independently represent H, Cl, F, CF₃, or OCF₃; X³², R³¹, A³¹, Y³¹, and Z³¹ represent the same things as those described in claim 1, respectively; R represents R³¹; F, CF₃, OCF₃ represents any one of F, CF₃, and OCF₃; and (F) represents any one of H and F).

6. The liquid crystal composition according to claim 5 including:
the one or more compounds selected from compounds represented by General Formula (LC0-1) and/or General Formula (LC0-2); and
one or more compounds selected from the group consisting of compounds represented by General Formulae (LC4-1) to (LC4-12), 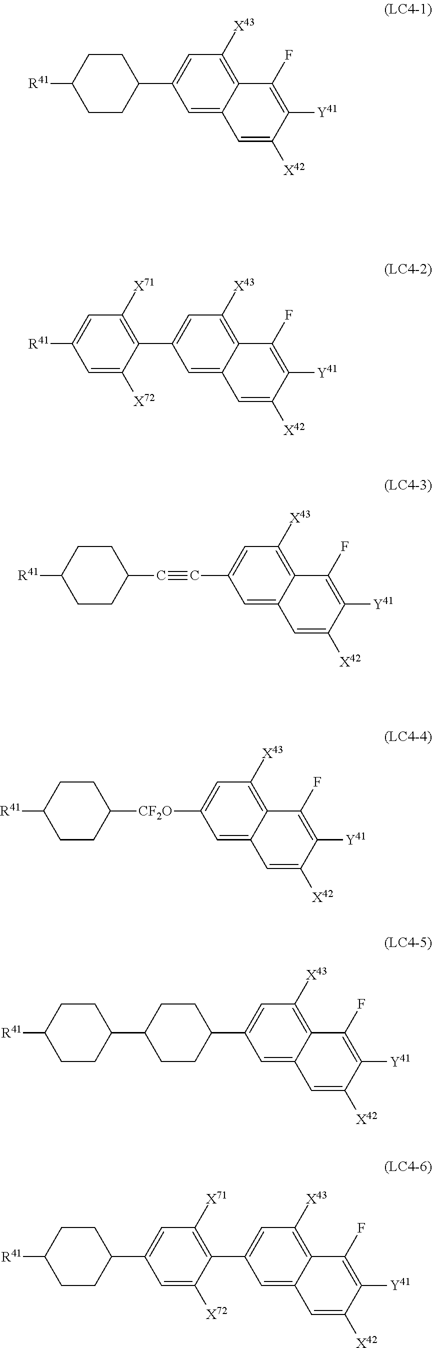 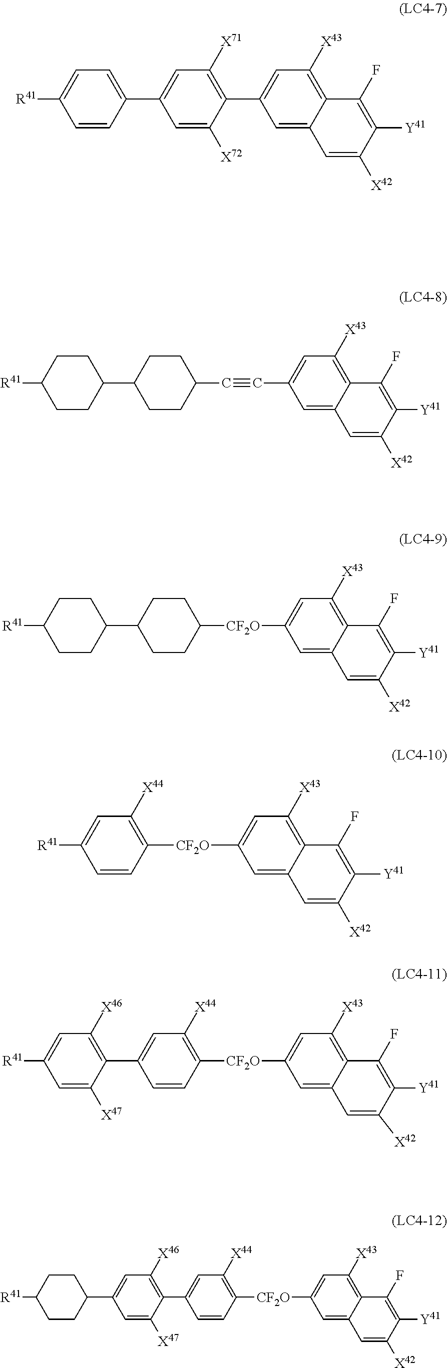
(wherein X⁴⁴, X⁴⁶, X⁴⁷, X⁷¹, and X⁷² each independently represent H, Cl, F, CF₃, or OCF₃; and X⁴², X⁴³, R⁴¹, and Y⁴¹ represent the same things as those described in claim 1, respectively).

7. The liquid crystal composition according to claim 1 including:
the one or more compounds selected from compounds represented by General Formula (LC0-1) and/or General Formula (LC0-2); and
one or more compounds selected from the group consisting of compounds represented by General Formulae (LC5-1) to (LC5-14), 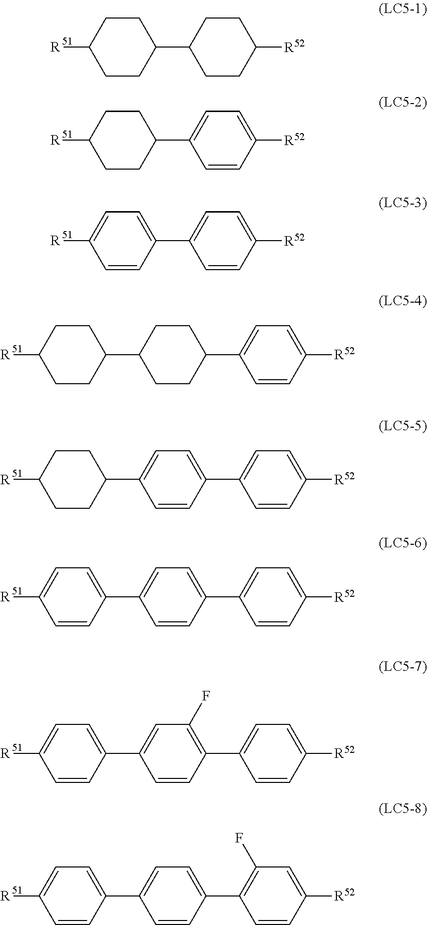 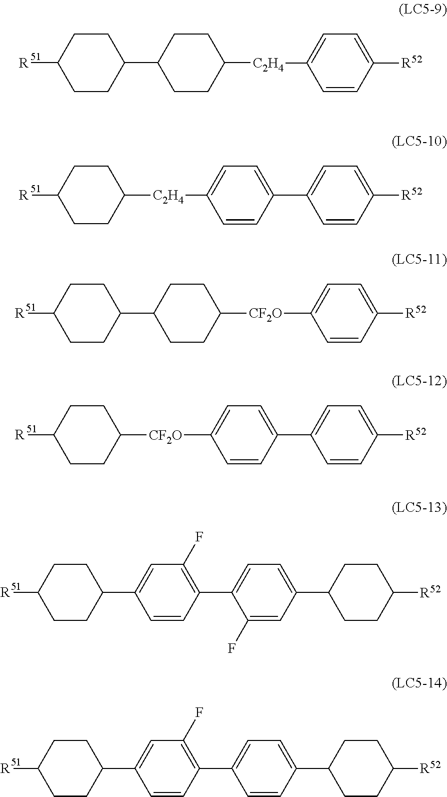
(wherein R⁵¹ and R⁵² represent the same things as those described in claim 1, respectively).

8. The liquid crystal composition according to claim 1 including one or more polymerizable compounds.

9. The liquid crystal composition according to claim 1 including one or more antioxidants.

10. The liquid crystal composition according to claim 1 including one or more UV absorbers.

11. A liquid crystal display element comprising the liquid crystal composition according to claim 1.

12. A liquid crystal display element used for active-matrix driving, the liquid crystal display element comprising the liquid crystal composition according to claim 1.

13. A liquid crystal display element used in TN mode, OCB mode, IPS mode, or VA-IPS mode, the liquid crystal display element comprising the liquid crystal composition according to claim 1.

14. A polymer-stabilized liquid crystal display element used in TN mode, OCB mode, IPS mode, or VA-IPS mode, the polymer-stabilized liquid crystal display element being prepared by polymerizing the polymerizable compounds included in the liquid crystal composition according to claim 8 under application of a voltage or without application of a voltage.
